(19) United States
(12) Patent Application Publication
(10) Pub. No.: US 2020/0326893 A1
(43) Pub. Date: Oct. 15, 2020

(54) Methods and Apparatus for Printing Device Process Recording and Display

(71) Applicant: KYOCERA Document Solutions Inc., Osaka (JP)

(72) Inventors: Neil-Paul Payoyo Bermundo, Glendora, CA (US); Luis David Barriere, Los Angeles, CA (US)

(21) Appl. No.: 16/384,867

(22) Filed: Apr. 15, 2019

(51) Int. Cl. G06F 3/12

(52) U.S. Cl. CPC G06F 3/121; G06F 3/1234; G06F 3/1297; G06F 3/1285; G06F 3/1259

(57) ABSTRACT

Methods and apparatus for recording and indicating events associated with printing devices are provided. A computing device can receive a request to record information about a printing device. The request can specify a plurality of types of information related to a time-oriented sequence of events associated with the printing device. After receiving the request, the computing device can record the specified plurality of types of information related to the time-oriented sequence of events. The computing device can indicate the time-oriented sequence of events associated with the printing device using the recorded plurality of types of information.

### BACKGROUND

Printing devices have increased in number and geographic footprint throughout the world and have become increasingly connected to networks. These networks can include a print server. Typically, when one or more documents and/or other print data are scheduled to be printed, the print data is either directly sent to one printing device, or sent to a print server. In some cases, printing devices include scanning components for creating electronic copies of original paper documents. Such printing devices can be used to scan in paper documents and perhaps transmit corresponding electronic copies.

The networks can include one or more printing devices. Some or all of the printing devices can have different features, functions, and capabilities. Some or all of the printing devices can generate log files to record operations performed using the printing devices, such as printing operations, scanning operations, and document communication operations.

### SUMMARY

In one aspect, a method is provided. A computing device receives a request to record information about a printing device. The request specifies a plurality of types of information related to a time-oriented sequence of events associated with the printing device. After receiving the request, the computing device is used to record the specified plurality of types of information related to the time-oriented sequence of events. The computing device indicates the time-oriented sequence of events associated with the printing device using the recorded plurality of types of information.

In another aspect, a computing device is provided. The computing device includes one or more processors and data storage. The data storage is configured to store at least computer-readable instructions. The computer-readable instructions include instructions that, when executed by the one or more processors, cause the computing device to perform tasks. The tasks include: receiving a request to record information about a printing device, the request specifying a plurality of types of information related to a time-oriented sequence of events associated with the printing device; after receiving the request, recording the specified plurality of types of information related to the time-oriented sequence of events; and indicating the time-oriented sequence of events associated with the printing device using the recorded plurality of types of information.

In another aspect, an article of manufacture is provided. The article of manufacture includes non-transitory data storage storing at least computer-readable instructions that, when executed by one or more processors of a computing device, cause the computing device to perform tasks. The tasks include: receiving a request to record information about a printing device, the request specifying a plurality of types of information related to a time-oriented sequence of events associated with the printing device; after receiving the request, recording the specified plurality of types of information related to the time-oriented sequence of events; and indicating the time-oriented sequence of events associated with the printing device using the recorded plurality of types of information.

Other aspects, embodiments, and implementations will become apparent to those of ordinary skill in the art by reading the following detailed description, with reference where appropriate to the accompanying drawings.

### BRIEF DESCRIPTION OF THE FIGURES

FIG. 1 is a schematic block diagram illustrating a computing device, in accordance with example embodiments.

FIG. 2 is a diagram illustrating a network, in accordance with example embodiments.

FIG. 3 is another diagram illustrating a portion of the network of FIG. 2, in accordance with example embodiments.

FIG. 4 illustrates user interfaces related to recording of data for printing devices, in accordance with example embodiments.

FIG. 5 is a flowchart for a method for controlling recording data for printing devices, in accordance with example embodiments.

FIG. 6 is a flowchart for a method for performing process recording, in accordance with example embodiments.

FIG. 7 shows data files related to events recorded during process recording, in accordance with example embodiments.

FIG. 8 is a flowchart for a method for playing back data recorded for printing devices, in accordance with example embodiments.

FIGS. 9 and 10 illustrate user interfaces for playing back data recorded for printing devices, in accordance with example embodiments.

FIG. 11 is a flowchart for a method, in accordance with example embodiments.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

### I. Overview

Techniques and apparatus for recording and indicating events associated with printing devices are described. In operation of some printing devices, various problems and/or issues can occur, where these problems/issues may be related to software and/or hardware errors of a printing device. To solve these issues, error-related data can be gathered from the printing devices, such as logs and memory data (e.g., core dumps). The error-related data can be useful in the analysis, diagnosis, troubleshooting, and implementation of a solution, if needed, to these software errors.

However, if the error-related data is of poor quality, or if a software error is difficult to replicate the problem, software error resolution can be delayed. Manual gathering of information about how to reproduce an error and gaps in error-related data, for example, by interviewing a user who detected an error, can lead to inaccuracies or ambiguities in the collected information.

For example, if a procedure that is supposed to reproduce a software error is inaccurate, the inaccurate procedure could mislead engineers attempting to address the software error and could consequently lead to an incorrect attempt to solve the software error. And, communication between a customer and the manufacturer's engineers to get more accurate information about how to reproduce an error could take a relatively long time, possibly further. These software errors can adversely affect the business and workflow of customers using the printing devices and tarnishing the reputation of the manufacturer of the printing device.

In some cases, custom printing device software and/or firmware can be provided to the customer to gather additional error-related data. However, providing and installing such custom software and communication of error-related data can take considerable time, effort, and expense on the part of both the customer and the manufacturer to correct the error.

The herein-described techniques can gather more accurate error-related data for describing, illustrating, and reproducing problems and issues on printing devices and similar devices. Some solutions include using the above-mentioned error-related data (e.g., logs, core dumps, etc.) that may be captured and collected by firmware of a printing device. Besides the error-related data, information about how to reproduce an error are mainly gathered from interviews with users (e.g., testers, engineers, or customers), where the users describe what they were doing when the error occurred, what settings were used on the printing device at that time, and what documents and/or other data were being processed by the printing device.

To address such issues in obtaining information about how to reproduce an error and error-related data, the herein-described techniques can include utilizing software and perhaps hardware of one or more computing devices, including printing devices, to perform “process recording” or recording events related to printing device operations. Process recording can involve capturing data about printing device operations as one or more time-oriented sequences of events. A user of the printing device can select print settings to activate and/or deactivate process recording on a computing device and/or on a printing device. These settings can control process recording on a per-device and/or a per-print-job basis. Then, when the user suspects a printing device has an error; e.g., the user believes a print job has incorrect output, the user can select the appropriate settings to activate process recording and re-attempt the erroneous print job. The herein-described process recording software can then record event-related data related to the (erroneous) print job on one or more devices; e.g., computing devices, printing devices, servers. Then, the event-related data saved via process recording can be provided to the appropriate manufacturer personnel (e.g., sales support, software development, etc.) to diagnose and address the error.

If event-related data about most, if not, all events related to software and/or hardware error(s) are captured as time-oriented sequences of events, the data about the time-oriented sequences of events can inform a manufacturer about causes of a customer's software and/or hardware errors. The time-oriented sequences of events also can indicate what actions can be used to reproduce the software and/or hardware errors. The data about the time-oriented sequences of events can corroborate and enhance available manually-gathered information. For example, if a time-oriented sequence of events includes events related to a printing device user interface (e.g., a front panel of the printing device) and printing device firmware, the time-oriented sequence of events could indicate arrival and completion times of print jobs, timing of network events related to the printing device, and information about firmware processing during print jobs. In some cases, the time-oriented sequence of events can indicate how to reproduce software and/or hardware errors without having to communicate with the customer, thereby saving the customer time and effort during error resolution.

The events that can be captured can include, but are not limited to, user-interface related events (e.g., events captured using keystroke data, mouse/touch pad data, button press data) configuration-related events; (e.g., events related to reading and/or setting of one or more configuration parameters and/or other data, events recording values of the one or more configuration parameters and/or other data, where the configuration parameters and/or other data about a printing device can relate to a printer engine, printer firmware, feature settings, finishing option settings, system settings, etc.); print-job related data (e.g., document names, types, sizes, locations, page counts, print-jam related data); sub-device related events; (e.g., device door opening and/or closing events, print tray opening and/or closing events, device cover opening and/or closing events, control-panel related events, diagnostic events related to sub-devices), events recorded using audio information, and/or events recorded using video information. Example sub-devices of a printing device include, but are not limited to, a door of the printing device, a tray of the printing device, a lever of the printing device, a cover of the printing device, a front panel of the printing device, and a control panel of the printing device.

In some examples, data about events related to printing devices can be recorded from multiple devices. For example, data about events related to a print job can be recorded at a computing device that submits the print job, a print server that communicates the print job to a printing device, and/or at the printing device that processes the print job. Capturing events from multiple devices can enable a time-oriented sequence of events to represent events from multiple devices. Time-oriented sequences of events coming from multiple devices both can increase understanding of circumstances leading to an error and can enhance and/or verify other error-related data, such as manually-reported data.

Data captured using process recording can be “played back” or displayed and/or otherwise provided one or more times after being captured. A playback of event-related data captured using process recording can involve processing the event-related data to display and/or otherwise present the event-related data, perhaps as one or more time-oriented sequences of events. A playback of event-related data can include displaying/presenting the event-related data from a beginning of the event-related data to an end of the event-related data. A playback can include display and/or other presentation of text, video, audio, and/or other data captured using process recording.

In some examples, process recording software can include a software playback component for playing back data/events recorded by process recording. The playback component can enable playback and related processing of captured of recorded event-related data. For example, the playback component can provide a playback which shows a time-oriented sequence of events that happened at one or more printing devices and/or computing devices when a problem occurred.

The playback component can start and execute processes as indicated in data captured during process recording. Examples of these processes include, but are not limited to, one or more processes of a printing device and/or a computing device associated with color registration, color calibration, factory reset, memory initialization, disk checking or formatting, maintenance mode, region setting, logging, profiling, a printer engine, and/or a user interface. The playback component can provide displays based on the data captured during process recording that related to input and/or output communicated using a user interface; e.g., user inputs, message prompts, error displays, etc. In some examples, the playback component can provide an animation of a time-oriented sequence of events that were captured during process recording. In some examples, the playback component can audibly output information about the time-oriented sequence of events; i.e., read aloud some or all event-related data. In some examples, the playback component can use visual hints, including but not limited to, color highlighting of buttons and controls to illustrate user-interface-related inputs and/or outputs.

In some examples, process recording can be performed with minimal effect on existing functionality, load and performance of a printing device and/or computing device. For printing devices, process recording can provide comprehensive coverage of printing/scanning/faxing processes covering desktop and document editing, network transfer, and printing device processing and operation.

Process recording can have a single module configuration, a two-module configuration, or a network-wide configuration. In a single module configuration, an integrated module inside a printing device or other computing device is used for process recording. The integrated module can have its own memory, storage and processor to perform calculations, processing and messaging for process recording, thereby allowing the printing device (or other computing device) to perform its tasks as usual, including normal processing of print jobs, with little or no effect on the performance of existing functionality. Use of such an integrated module capable of gathering data and monitoring events for process recording can aid in maintenance, debugging, and analysis of printing device (or other computing device) features and components.

In a two-module configuration, two modules can facilitate process recording: one module of a printing device (such as the integrated module discussed above) and one module of device external to the printing device to carry out additional process-recording related activities; e.g., recording of events that occur outside the printing device, data file processing, playback, simulations, etc.

In a network-wide configuration of process recording, process recording activities can occur in a network of printing devices, desktop systems, laptop systems, mobile devices, network server(s) and/or /Internet (cloud) servers. A centralized process recording system of the network; e.g., hosted on one or more servers, can be used to coordinate and/or control process recording activities throughout the network. For example, a logging service for recording and storing event-related data captured during process recording can be coordinated and/or controlled by the centralized process recording system. This centralized process recording system can gather, consolidate, store, process, and/or organize event-related data, data files, logs, memory dumps, etc. associated with process recording activities that occur throughout the network; i.e., connected printing devices and/or other devices can then report event-related data, data files, logs and processes to the centralized process recording system. The centralized process recording system can: determine whether multiple print jobs are coming from one device or from multiple devices, coordinate sequences of print jobs in the network, detect network delays in transmission of print jobs (i.e., to determine if network delay can be a factor towards the problem in processing of print jobs), and/or record data, including sequencing information, about operating systems and applications that submit/generate print jobs received at printing devices in the network.

In some examples, process recording can be performed with little or no new hardware for process recording. For example, printing device and/or other device software can be used to record event-related data, including network transmissions. Also, existing sensors, microphones, and/or cameras can be used for process recording; e.g., to record events while trying to confirm the occurrence of a problem.

Using process recording to capture time-oriented sequences of events related to printing device errors (and perhaps errors of other types of devices) can shorten time taken to identify and accurately determine actions for reproducing these errors. Accurately determining actions for reproducing errors can save time for testing and development personnel tasked with reproducing errors, resolving the errors, and verifying solutions to errors. Further, accurately determining actions for reproducing errors can save customer time in describing the actions leading to these errors. In addition, better error-related data in the form of time-oriented sequences of events can reduce a number of iterations of software development, deployment, and reporting to resolve an error, thereby easing bug fixing for printing devices and reducing time, effort, expenses (and thus reducing dissatisfaction) with bugs in printing devices. As such, process recording of time-oriented sequences of events can assist consumers, technicians and users in reporting problems and reduce delays in communicating problems between customers and manufacturers.

### II. Computing Device and Printing System Examples

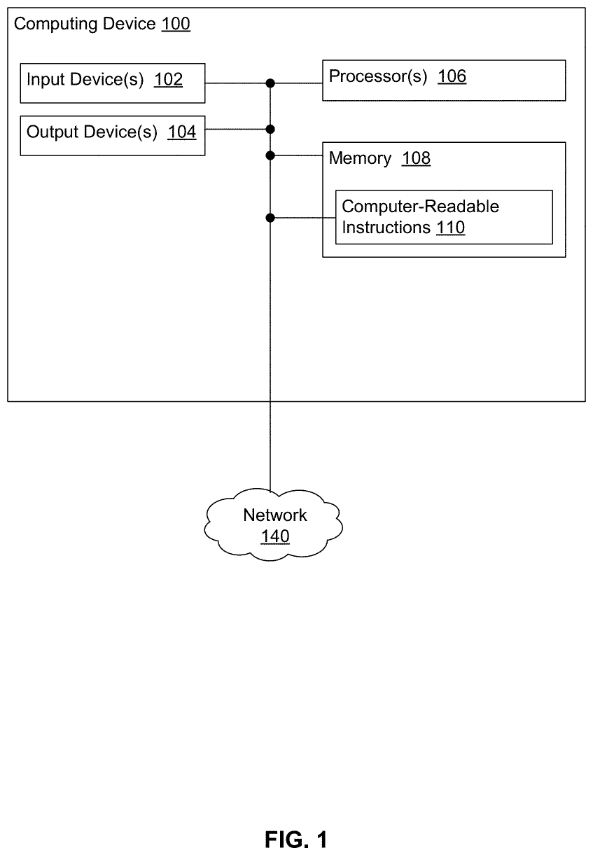

FIG. 1 is a schematic block diagram illustrating computing device 100, in accordance with example embodiments. In some embodiments, computing device 100 can be configured to perform at least part of the herein-described techniques for document distribution and/or functionality related to: process recording, a node, a process recorder node, a distributed storage system, network 140, 200, scanning/printing devices (SPDs) 210, 212, 214, 216, computing devices 220, 222, process recorder node(s) 230, distributed storage system 232, external storage device 310, dialogs 410, 420, 430, methods 500, 600, 800, 1100, data files 710, 730, and/or user interfaces 900, 1000.

Computing device 100 can include one or more input devices 102, one or more output devices 104, one or more processors 106 and memory 108. Input devices 102 can include user input devices, network input devices, sensors, and/or other types of input devices. For example, input devices 102 can include user input devices such as a touch screen, a keyboard, a keypad, a computer mouse, a track ball, a joystick, a camera, a voice recognition module, and/or other similar devices. Network input devices can include wired network receivers and/or transceivers, such as an Ethernet® transceiver, a Universal Serial Bus (USB) transceiver, or similar transceiver configurable to communicate via a twisted pair wire, a coaxial cable, a fiber-optic link, or a similar physical connection to a wireline network, such as wired portions of one or more of networks 140, 200 and/or wireless network receivers and/or transceivers, such as a Bluetooth® transceiver, a ZigBee® transceiver, a Wi-Fi® transceiver, a WiMAX™ transceiver, a wireless wide-area network (WWAN) transceiver and/or other similar types of wireless transceivers configurable to communicate via a wireless network, such as wireless portions of one or more of networks 140, 200. Sensors can include devices configured to measure conditions in an environment of computing device 100 and provide data about that environment, such data including, but not limited to, location data, velocity (speed, direction) data, acceleration data, and other data about the environment for computing device 100. Example sensors include, but are not limited to, GPS sensor(s), location sensors(s), gyroscope(s), accelerometer(s), magnetometer(s), camera(s), light sensor(s), infrared sensor(s), and microphone(s). Other input devices 102 are possible as well.

Output devices 104 can include user display devices, audible output devices, network output devices, and/or other types of output devices. User display devices can include one or more printing components, liquid crystal displays (LCD), light emitting diodes (LEDs), lasers, displays using digital light processing (DLP) technology, cathode ray tubes (CRT), light bulbs, and/or other similar devices. Audible output devices can include a speaker, speaker jack, audio output port, audio output device, headphones, earphones, and/or other similar devices. Network output devices can include wired network transmitters and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network, such as wired portions of one or more of networks 140, 200 and/or wireless network transmitters and/or transceivers, such as a Bluetooth® transceiver, a ZigBee® transceiver, a Wi-Fi® transceiver, a WiMAX™ transceiver, a wireless wide-area network (WWAN) transceiver and/or other similar types of wireless transceivers configurable to communicate via a wireless network, such as wireless portions of one or more of networks 140, 200. Other types of output devices can include, but are not limited to, vibration devices, haptic feedback devices, and non-visible light emission devices; e.g., devices that emit infra-red or ultra-violet light. Other output devices 104 are possible as well.

Processor(s) 106 can include one or more general purpose processors, central processing units (CPUs), CPU cores, and/or one or more special purpose processors (e.g., graphics processing units (GPUs), digital signal processors (DSPs), field programmable gated arrays (FPGAs), application specific integrated circuits (ASICs), etc.). Processor(s) 106 can be configured to execute computer-readable instructions 110 that are contained in memory 108 and/or other instructions as described herein.

Memory 108 can include one or more computer-readable storage media configured to store data and/or instructions that can be read and/or accessed by at least one of processor(s) 106. The one or more computer-readable storage media can include one or more volatile and/or non-volatile storage components, such as optical, magnetic, organic or other memory or disc storage, which can be integrated in whole or in part with at least one of processor(s) 106. The computer-readable storage media can include one or more components that store data for short periods of time like register memories, processor caches, and/or random access memories (RAM). The computer-readable storage media can include non-transitory computer readable media that stores program code and/or data for longer periods of time, such as secondary or persistent long term storage; for example, read only memory (ROM), optical or magnetic disks, compact-disc read only memory (CD-ROM). In some embodiments, memory 108 can be implemented using a single physical device (e.g., one optical, magnetic, organic or other memory or disk storage unit), while in other embodiments, memory 108 can be implemented using two or more physical devices.

Memory 108 can store computer-readable instructions 110 that, when executed by one or more of processor(s) 106, can cause a computing device (e.g., computing device 100) to perform functions, such as but not limited to, functions related to herein-described procedures, techniques, devices, networks, methods, features, and/or scenarios. In some examples, computer-readable instructions 110 can include instructions to carry out at least part of the herein-described functionality of a node, a process recorder node, a scanning/printing device, a computing device, and/or a distributed storage system.

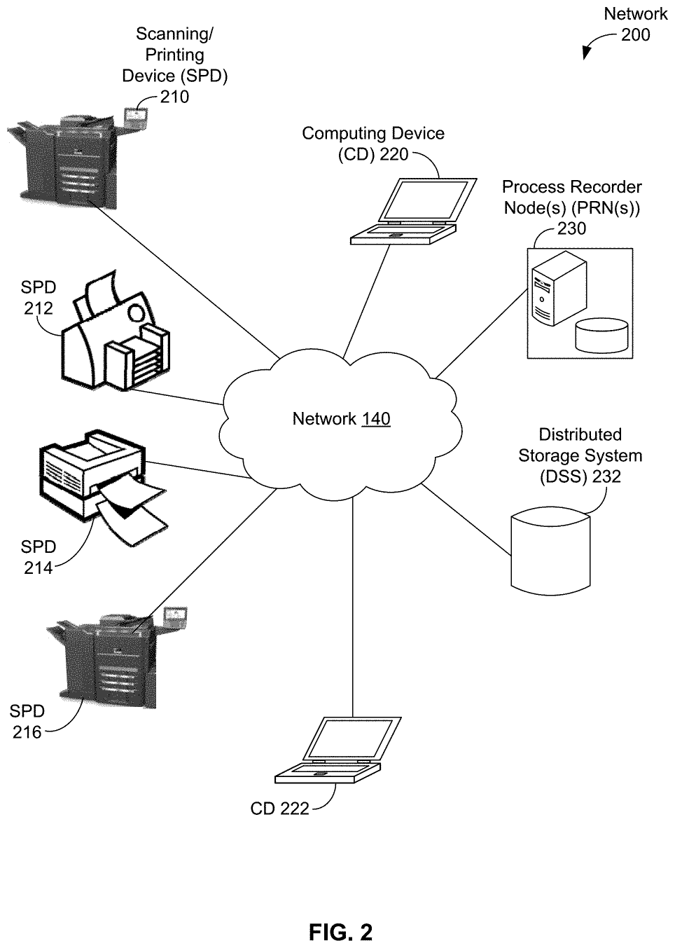

FIG. 2 is a diagram illustrating network 200, in accordance with example embodiments. Network 200 includes scanning/printing devices 210, 212, 214, 216, computing devices 220, 222, one or more process recorder nodes 230, and/or distributed storage system 232. In some examples, network 200 can have more, fewer, and/or different types of nodes, scanning/printing devices, computing devices, server computing devices, and/or other devices than indicated in FIG. 2. In some examples, network 200 is a peer-to-peer network with scanning/printing devices 210, 212, 214, 216, computing devices 220, 222, process recorder node(s) 230 and distributed storage system 232 acting as peers while being connected by network 140.

Scanning/printing devices 210, 212, 214, 216 can include components configured to scan, print, copy, e-mail, account for, communicate and/or otherwise process documents and/or files that are originally available either on paper or electronically. For example, some or all of scanning/printing devices 210, 212, 214, 216 can include scanning components for creating electronic copies of original paper documents and/or for generating electronic data via OCR or other techniques from the original paper documents; e.g., generating paper-form data from a paper form or other paper document. After processing by one or more of scanning/printing devices 210, 212, 214, 216, the paper-form data, documents, and/or files can be subsequently available either on paper or electronically, as requested. That is, scanning/printing devices 210, 212, 214, 216 can process a paper document PAPERD or electronic document ED by at least: creating an electronic document ED1 representing the contents of PAPERD (e.g., scan PAPERD to create ED1), making one or more paper copies of PAPERD, printing one or more copies of ED and/or ED1 on one or more types of paper, make one or more electronic copies of ED and/or ED1, change a format of ED and/or ED1 (e.g., perform OCR) scanning, convert a file format used to store ED and/or ED1), maintain remotely-accessible storage (e.g., a document box) enabling other devices than scanning/printing devices 210, 212, 214, 216 to use/access ED and/or ED1, and/or communicate the contents of ED and/or ED1 to/from another device. In some cases, creating the electronic document ED1 representing the contents of PAPERD can include creating paper-form data PFD representing part or all of the contents of PAPERD.

A document box can be storage allocated to an entity (e.g., a user, an administrator, a company, another type of entity) on a printing device, a scanning/printing device, print server, or another device so the entity can keep and maintain documents, files, and/or other data. In some embodiments, the document box can be accompanied by and/or include storage for personal data, such as address book and/or device accounting storage. The document box, address book, and device accounting storage can store one or more documents, files, personal data, and/or other data, such as contacts, usage and usage limits. In some examples, the herein-described techniques for document distribution can be used for one or more documents stored in a document box.

In some examples, scanning/printing devices 210, 212, 214, 216 can perform other tasks and/or other processing as well. Scanning/printing devices 210, 212, 214, 216 can include products from various manufacturers with variations in color, speed, computing power, functionality, network connectivity, and/or other features.

In some examples, some or all of scanning/printing devices 210, 212, 214, 216 can be connected to network 140 through one or more, possibly different, network protocols. Data can be transmitted between scanning/printing devices 210, 212, 214, 216, computing devices 220, 222, process recorder node(s) 230 and/or distributed storage system 232, over wired and/or wireless links between computers, computing devices, nodes, printing devices, scanning/printing devices, servers, and network 140. The format of each respective data transmission between devices in network 200 can include one or more of a variety of different formats including: text formats, image formats, extensible mark-up language (XML), Simple Network Maintenance Protocol (SNMP) formats, database tables, text including OCR'd text, a flat file format, or another format.

Communications between the computers, computing devices, nodes, printing devices, scanning/printing devices, servers, can include: computing devices 220, 222, process recorder node(s) 230 and/or distributed storage system 232, sending and/or receiving data for scanning and printing jobs performed by scanning/printing devices 210, 212, 214, 216; scanning/printing devices 210, 212, 214, 216 sending alert, status, error, device information, colorant-usage information, maintenance-event information, and/or other messages to computing device 220 and/or computing device 222; and a document management system (not shown in FIG. 2) to inform other devices about colorant-usage, maintenance, error, and/or other conditions of the printing devices and/or scanning/printing devices; e.g., idle, printing, sleeping, paper jam, low or out of paper, low or out of toner/ink, etc.; and scanning/printing devices 210, 212, 214, 216, computing devices 220, 222, process recorder node(s) 230 and/or distributed storage system 232, sending and/or receiving data related to securely storing and/or retrieving documents as described herein. Other communications between nodes, computing devices, scanning/printing devices 210, 212, 214, 216, computing devices 220, 222, process recorder node(s) 230 and/or distributed storage system 232, are possible as well, such as, but not limited to, communications related to one or more maintenance and management operations.

In some examples, computing devices 220, 222 can create, obtain, update, display, distribute, store, retrieve, and/or delete documents using network 200. For example, computing device 220 and/or computing device 222 can act as a herein-described process recorder node and/or act as part or all of a distributed storage system.

Process recorder node(s) 230 can include one or more computing devices, each acting as one or more herein-described process recorder nodes at least to store data and/or software related to process recording. In some examples, some or all of process recorder node(s) 230 can also be part of distributed storage system 232.

Distributed storage system 232 can provide storage at least for a distributed storage system utilized by the herein-described techniques for process recording. In some examples, distributed storage system 232 can communicate with one or more other computing and/or data storage devices that can provide storage for one or more distributed storage systems utilized by the herein-described process recording techniques.

Data for process recording can be communicated using network 200. This data about process recording can include, but is not limited to, data files, software for process recording, commands related to process recording, event-related data, error-related data, time-oriented sequences of events, and tokens related to process recording. Other data can be communicated using network 200 as well.

Event-related data can include information about one or more events that occur on a computing device or printing device. Event-related data can include text, binary data, video data, audio data, and/or other types of data. Example events for a device include, but are not limited to, configuration-related events regarding settings/configuration of the device; user-interface related events regarding data received from and/or provided to one or more user interfaces of the computing device; process-related events regarding threads, processes, and/or applications executing on the device, input-output-related events regarding input and/or output activities at one or more ports, cards, drives, disks, and/or other input/output devices of the device; sub-device related events regarding activities involving sub-devices of the device; network-related events regarding signals, packets, addresses, and/or other network-related information sent and/or received by the device, and memory-related events regarding memory allocation, memory deallocation, and memory/core dumps of the device. In some examples, the events recorded as event-related data can include one or more events that occur at a computing device or printing device while carrying out a print job and/or other procedure.

Event-related data that can be recorded by process recording software at a computing device can include, but is not limited to: configuration data for the computing device recording selected settings related to a print job (or other procedure) and/or other settings, options, etc., user-interface data about data received from and/or provided to one or more user interfaces of the computing device; process data about which processes and applications executing for the print job (or other procedure) and/or were executing on the computing device while the print job (or other procedure) was being created, sent, receiving, and/or carried out, device-related data about which one or more computing and/or printing devices involved with creating, sending, receiving, and/or carrying out the print job (or other procedure); input/output data related to input/output actions at one or more ports, cards, drives, disks, and/or other input/output devices of the computing device that were related to the print job (or other procedure); network data related to signals, packets, addresses, and/or other network-related information sent and/or received by the computing device that were related to the print job (or other procedure); timing data such as timestamps of events occurring at the computing device related to the print job (or other procedure); and memory data related to files, core dumps, logs, RAM, and/or other memory of the computing device that was allocated, used, and/or deallocated and was related to the print job (or other procedure).

Event-related data that can be recorded by process recording software at a printing device can include, but is not limited to, configuration data for the printing device recording selected settings related to a print job (or other procedure) associated with the printing device, data about a printer engine, printer firmware versions, front panel configuration, feature and option settings, finishing options, system settings and maintenance settings of the printing device, user-interface data for the printing device about data received from and/or provided to one or more user interfaces of the printing device, sub-device event data for the printing device, such as data about doors, covers, trays, finishing devices, etc. of the printing device, process data about which processes of the printing device were executed for the print job (or other procedure) and/or were executing while the print job (or other procedure) was being created, sent, receiving, and/or carried out, device-related data about which one or more computing and/or printing devices involved with creating, sending, receiving, and/or carrying out the print job (or other procedure); input/output data related to input/output actions at one or more ports, cards, drives, disks, and/or other input/output devices of the printing device that were related to the print job (or other procedure); network data related to signals, packets, addresses, and/or other network-related information sent and/or received by the printing device that were related to the print job (or other procedure); timing data such as timestamps of events occurring at the printing device related to the print job (or other procedure); and memory data related to files, core dumps, logs, RAM, and/or other memory of the printing device that was allocated, used, and/or deallocated and was related to the print job (or other procedure).

In some embodiments, one or more additional computing devices, e.g., one or more servers, printing devices, scanning/printing devices, nodes, and/or other computing devices, can be used in network 200 to perform additional functions, such as functions for one or more document solutions, managed print services, and/or other functions.

### III. Apparatus and Methods for Recording Information Related to Printing Devices

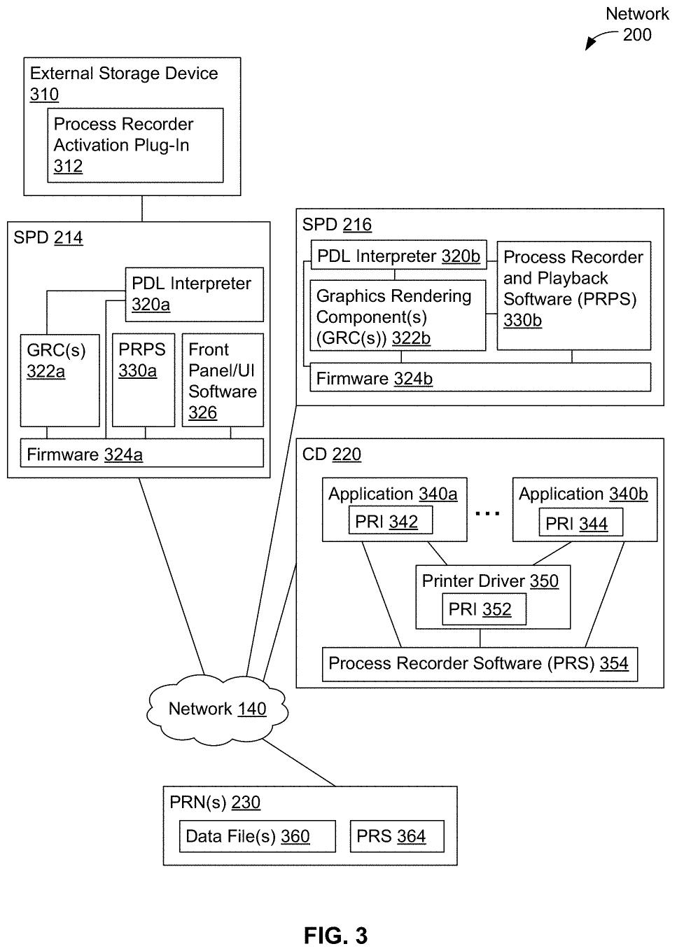

FIG. 3 is a diagram illustrating a portion of network 200, in accordance with example embodiments. In particular, FIG. 3 shows network 140 connecting scanning/printing devices 214, 216, computing device 220, and process recorder node(s) 230 and shows scanning/printing device 214 directly connected to external storage device 310.

Scanning/printing devices 214, 216 are shown having respective page description language (PDL) interpreters 320a, 320b, respective one or more graphics rendering components 322a, 322b, respective firmware 324a, 324b, and respective process recorder and playback software (PRPS) 330a, 330b. Each of page description language interpreters 320a, 320b can receive a print job expressed in a page description language and output corresponding commands to render the print job. A PDL can be a language that describes a document or pages in a print job. Examples of page description languages include, but are not limited to, Kyocera PDL (KPDL), PCL 5 (Printer Command Language), PCLXL (i.e., PCL 6), PostScript. PDF (Portable Document Format) and XPS (XML Paper Specification). In some examples, image formats such as, but not limited to JPG and Tagged Image File Format (TIFF), can be supported by the PDL.

Process recorder and playback software 330a, 330b can include one or more printer engine process recorders for receiving and recording data for process recording provided by one or more components of a printing device and/or one or more playback components. For example, process recorder and playback software 330a executing on scanning/printing device 214 can run in the background and can receive event-related data from components of scanning/printing device 214, such as but not limited to page description language interpreter 320a, graphics rendering component 322a, firmware 324a, and front panel/user interface (UI) software 326. After receiving the event-related data, process recorder and playback software 330a can save the data in a data file and/or elsewhere. Process recorder and playback software 330a can store the data locally; e.g., on scanning/printing device 214 and/or remotely; e.g., at process recorder node(s) 230 and/or distributed storage system 232.

In some examples, process recorder and playback software 330a can timestamp event-related data upon arrival; that is, process recorder and playback software 330a can record and perhaps store one or more times associated with arrival of event-related data. In some examples, process recorder and playback software 330a can verify that process recording is activated before storing data captured during process recording activities. In the context of scanning/printing device 216, recorder and playback software 330b can perform the procedures described in the context of recorder and playback software 330a and scanning/printing device 214.

The commands to render the print job can be provided to respective graphics rendering components 322a, 322b, which can execute the commands to render text and/or graphics of the print job to paper, to a file, and/or to a display. For example, each of graphics rendering components 322a, 322b can translate PDL commands or data received at respective scanning/printing devices 214, 216 into binary data for use by a printer engine of the respective scanning/printing device. Then, the printer engine can convert the binary data into pixels and the pixels can be rendered to paper and/or to an electronic file as instructed for the print job.

To render text and/or graphics of the print job, each of scanning/printing device 214 and scanning/printing device 216 can utilize respective firmware 324a, 324b to perform rendering tasks. Firmware 324a, 324b can perform other tasks for respective scanning/printing devices 214, 216; e.g., device management, interfacing with respective process recorder and playback software 330a, 330b to perform process recording activities.

Process recording can involve capturing, processing, and storing event-related data that may be related to one or more printing devices; e.g., one or more scanning/printing devices 214, 216. In some examples, process recording can involve capturing, processing, and storing event-related data that may be related to other devices than printing devices; e.g., computing devices, servers, nodes, etc. As such, process recording activities for a device, such as one of scanning/printing devices 214, 216, computing device 220, or a node of process recorder node(s) 230, can include, but are not limited to, activating process recording for the device, deactivating process recording for the device, capturing information about events occurring on the device as event-related data, processing event-related data, recording and/or saving event-related data, perhaps in a data file, and communicating recorded/saved event-related data; e.g., data files, to one or more other devices.

Scanning/printing device 214 also includes front panel/user interface software 326 for performing user interface related activities, such as, but not limited to, receiving inputs, such as button presses/key presses, from a front panel and/or one or more other user interfaces of scanning/printing device 214, generating events, commands and/or other data based on received inputs, and providing displays using the front panel and/or the other user interface(s) of scanning/printing device 214.

As one example, a user interface of a printing device, such as front panel/user interface software 326 of scanning/printing device 214, can have user interface functionality, such as buttons and related screen displays, usable to at least enable activation and/or deactivation of process recording for the printing device. More specifically, a front panel of the printing device can include a control panel with buttons, display screen, touch screens, and/or a keyboard to select settings for the printing device, where the front panel can be utilized to show features and capabilities of the printing device; e.g., features and capabilities for printing, scanning, copying, faxing or sending jobs using the printing device. In some examples, the user interface of the printing interface; e.g., a front panel, can include one or more buttons and/or other user-interface elements to activate and/or deactivate process recording, such as button that toggles process recording on and off.

Computing device 220 is shown with software applications 340a . . . 340b. Some or all of software applications 340a . . . 340b can include a process recorder activation plug-in (PRI). For example, software application 340a includes process recorder activation plug-in 342 and software application 340b includes process recorder activation plug-in 344. Computing device 220 can also include printer driver 350 for communicating with one or more printing devices and perhaps one or more devices related to printing; e.g., one or more of process recorder node(s) 230, one or more devices of distributed storage system 232.

FIG. 3 shows that printer driver 350 includes process recorder activation plug-in 352. Some or all of software applications 340a . . . 340b and printer driver 350 can communicate with process recorder software (PRS) 354. For example, process recorder activation plug-ins 342, 344, and 352 of respective application 340a, application 340b, and printer driver 350 can enable communication with process recorder software 354 for process recording activities; e.g., to activate and/or to deactivate process recording on computing device 220.

A plug-in, such as but not limited to process recorder activation plug-in 312, process recorder activation plug-in 342, process recorder activation plug-in 344, and process recorder activation plug-in 352, can be used to activate and perhaps deactivate process recording. In examples where a plug-in is associated with an application or printer driver, such as but not limited to process recorder activation plug-in 342, process recorder activation plug-in 344, and process recorder activation plug-in 352, the plug-in can determine whether process recording is activated. Then, while process recording is activated, the plug-in can perform computing-device process recording activities for the associated application or printer driver. The computing-device process recording activities can include, but are not limited to, gathering key strokes, recording user interface device (e.g., mouse, touch screen) inputs such as clicks, movements, presses, drags, drops, etc., recording user device outputs such as screen displays, and/or recording audio and/or video. Data captured during computing-device process recording activities by the plug-in can be stored, such as in one or more process recording data files.

Process recorder software 354 can be used to perform process recording activities for computing device 220 by providing one or more services to a computing device, such as computing device 100. These services of process recorder software 354 can include, but are not limited to, a logging service and a system monitoring service. In some examples, the logging service and the system monitoring service can be combined as one system service.

The logging service can store data captured during process recording activities. For example, data captured by a plug-in can be provided to the logging service of process recorder software 354, and the logging service can store the captured data in a data file and/or elsewhere. The logging service can store the data locally; e.g., on computing device 220 and/or remotely; e.g., at process recorder node(s) 230 and/or distributed storage system 232. In some examples, the logging service can verify that process recording is activated before storing data captured during process recording activities.

Process recorder software 354 can also include a system monitoring service. The system monitoring service can include one or more processes, including one or more background processes, for performing system wide monitoring for process recording. The system monitoring service can verify that process recording is activated before monitoring for process recording; e.g., by checking whether process recording is activated for a printer driver, application, and/or for a computing device. After verifying that process recording is activated, the system monitoring service executing on a computing device can perform at least the computing-device process recording activities for the computing device mentioned above in the context of a plug-in. In addition to performing the computing-device process recording activities, the system monitoring service can gather running processes to determine whether the running processes can affect printing behavior or print job generation.

As mentioned above, process recorder and playback software 330a, 330b can record event-related data for printing devices and process recorder software 354 can record event-related data for computing devices. Then, event-related data recorded on multiple devices; e.g., on both scanning/printing device 214 and computing device 220, on multiple computing devices and/or multiple printing device, can be combined and consolidated, perhaps with data gathered from other sources. Then, playback of event-related data can include playback of event-related data obtained from one source; e.g., either scanning/printing device 214 or computing device 220, and/or playback of event-related data that has been combined and consolidated from multiple sources.

Some or all of process recorder and playback software 330a, process recorder and playback software 330b, and process recorder software 354 can have one or more playback components. The playback component(s) of process recorder and playback software 330a, process recorder and playback software 330b, and/or process recorder software 354 can enable playback and related processing of recorded event-related data. For example, the playback component of process recorder and playback software 330a can provide a playback which shows a time-oriented sequence of events that happened at scanning/printing device 214 and/or one or more other devices; e.g., computing device 220, scanning/printing device 216, a print server. Similarly, the playback component of process recorder and playback software 330b can provide a playback which shows a time-oriented sequence of events that happened at scanning/printing device 216 and/or one or more other devices. And, the playback component of process recorder software 354 can provide a playback which shows a time-oriented sequence of events that happened at computing device 220 and/or one or more other devices.

In some examples, some or all of process recorder and playback software 330a, process recorder and playback software 330b, and process recorder software 354 can generate a historical event report and/or diagram with events, data and timestamps from recorded event-related data; e.g., data stored in a data file. To generate the historical event report and/or diagram, some or all of process recorder and playback software 330a, process recorder and playback software 330b, and process recorder software 354 can create a report of the “steps to reproduce” an issue or problem. The report can include charts, tables, diagrams based on the recorded event-related data. While generating the historical event report and/or diagram, some or all of process recorder and playback software 330a, process recorder and playback software 330b, and process recorder software 354 can extract print jobs from logs, can extract call stacks and/or other data from one or more core dumps. Then, some or all of process recorder and playback software 330a, process recorder and playback software 330b, and process recorder software 354 can provide the report showing the steps to reproduce as a slideshow or other presentation. The report can be provided through playback of recorded audio/video, reading aloud of steps, highlighting or lighting up of buttons and controls, and through use of animation or other effects to show step-by-step re-enactment or re-execution of the recorded processes, events and data.

FIG. 3 illustrates process recorder node(s) 230 storing one or more data files 360 and process recorder software 364. FIG. 3 illustrates that process recording software (and perhaps related hardware) for performing process recording activities for a respective device can include, but is not limited to, process recorder activation plug-in 312 for external storage device 310; process recorder and playback software 330a, 330b for respective scanning/printing devices 214, 216; process recorder activation plug-ins 342, 344, 352 and process recorder software 354 for computing device 220; and process recorder software 364 of process recorder node(s) 230. FIG. 3 also illustrates that stored data for process recording can include, but is not limited to, one or more data files 360 stored on process recorder node(s) 230. Additional software and/or data for performing process recording activities can be utilized and/or stored within network 200; e.g., at some or all of computing device 220, scanning/printing devices 214, 216, process recorder node(s) 230, external storage device 310, and at other devices of network 200 not depicted in FIG. 3.

Event-related data can be organized as one or more time-oriented sequences of events. A time-oriented sequence of events can involve events occurring at one or more devices. For example, one time-oriented sequence of events SEQ1 related to scanning/printing devices 214 can include:
Event 1: at time T1, scanning/printing device 214 receives notification of an incoming print job J1
Event 2: at time T1+1 second (or T1+1, for short): a printing engine of scanning/printing device 214 wakes up
Event 3: at time T1+5, print job J1 is detected at scanning/printing device 214
Event 4: at time T1+15, print job J1 is available at scanning/printing device 214
Event 5: at time T1+15, scanning printing device 214 starts printing page 1 of print job J1
Event 6: at time T1+15, a graphics engine unit of scanning printing device 214 is activated to print page 1 of print job J1
Event 7: at time T1+18, page 1 of print job J1 is printed
Event 8: at time T1+22, page 2 of print job J1 is printed.
. . .
Event 33: at time T1+122, page 27 of print job J1 is printed.
Event 34: at time T1+122, print job J1 is completed.
Event 35: at time T1+122, a notification that print job J1 is sent
Event 36: at time T1+122, the graphics engine unit of scanning/printing device 214 is deactivated
Event 37: at time T1+127, the printing engine of scanning/printing device 214 is put to sleep
Event 38: at time T1+130, scanning/printing device 214 goes idle.

As a related example, suppose that print job J1 is initiated by computing device 220, and that process recording is activated for computing device 220. Then, process recorder software 354 can perform process recording activities that include capturing event-related data from computing device 220. Then, SEQ1 can be updated to include both the event-related data captured from scanning/printing device 214 and the event-related data captured from computing device 220; i.e., SEQ1 can be updated to include events occurring on computing device 220. For example, updating SEQ1 can involve adding the following events to SEQ1:
Event −2: at time T1−10, computing device 220 receives a user request to print document D1 on scanning/printing device 214
Event −1: at time T1−2, computing device 220 generates print job J1 to print document D1
Event 0: at time T1−1, computing device 220 starts sending print job J1 to a scanning/printing device 214
Event 3.1: at time T1+14, computing device 220 completes sending print job J1 to scanning/printing device 214
Event 35.1: at time T1+123, computing device 220 receives a notification from scanning/printing device 214 that print job J1 is complete
Event 35.2: at time T1+123, computing device 220 displays the notification from scanning/printing device 214 that print job J1 is complete.
   In this example, SEQ1 can be updated by: inserting events −2, −1, and 0 before Event 1 of pre-update SEQ1, inserting event 3.1 after Event 3 of pre-update SEQ1, and inserting events 35.1 and 35.2 after Event 35 of pre-update SEQ1. In this example, SEQ1 has events oriented in a time-forward fashion; that is, events are ordered in SEQ1 in an order where times of events increase/go forward. In other examples, a time-oriented sequence of events can be organized in a time-backward fashion, that is, events could be ordered in SEQ1 in an order where times of events decrease/go backward. In other examples, a time-oriented sequence of events can be organized in other fashions (e.g., oriented on multiple timelines, oriented on device-specific timelines, oriented based on a selected staring time and/or ending time). In other examples, more, fewer, and/or different events than indicated for SEQ1 can be included in a time-oriented sequence of events.

In the example of SEQ1, the event-related data from scanning/printing device 214 used to generate SEQ1 can be captured, processed, and/or stored by process recorder and playback software 330a, and the event-related data from computing device 220 used to generate (and update) SEQ1 can be captured, processed, and/or stored by one or more of process recorder plug-ins (PRIs) 342, 344, 352 and/or process recorder software 354.

Process recording can be initiated at a printing device, such as scanning/printing device 214 and/or scanning/printing device 216, by way of an external storage device, such as external storage device 310, and/or at a computing device, such as computing device 220. As an example, when external storage device 310 is initially communicatively coupled to a printing device, such as scanning/printing device 214, process recorder activation plug-in 312 can be executed to activate process recording for the printing device. In an example where external storage device 310 is communicatively coupled to scanning/printing device 214, event-related data captured during process recording by process recorder and playback software 330a and/or process recorder activation plug-in 312, can be saved on scanning/printing device 214 and/or on external storage device 310. For example, the event-related data can be saved in memory of scanning/printing device 214 and/or saved in memory of external storage device 310.

Event-related data can be transmitted to one or more other devices; e.g., a destination node, such as process recorder node(s) 230, a remote storage device, such as distributed storage system 232. In some examples, event-related data captured during process recording can be both saved and transmitted; that is, a first copy of the event-related data can be stored on first device and a second copy of the event-related data can be transmitted to a different device than the first device. Event-related data captured during process recording can be stored in one or more data files, such as, but not limited to, some or all of data file(s) 360 stored on process recorder node(s) 230.

In some examples, one device can activate and/or deactivate process recording on a different device. For example, when a user of computing device prints using an application, such as application 340a or application 340b, software in the application and/or a related printer driver (e.g., process recorder activation plug-in 342, 344, 352) can send a command with a print job to instruct a printing device to activate process recording; e.g., a print job command such as @PJL SET Process_Record “ON”. In some examples, the software in the application and/or the related printer driver can send a command with a print job to instruct a printing device to deactivate process recording; e.g., a print job command such as @PJL SET Process_Record “OFF”.

In an example where a printer driver is used to send commands in print jobs to instruct printing devices to enable process recording, the printer driver can have a user interface, such as a user interface for printer preferences, to control whether or not to send commands in print jobs to instruct printing devices to enable process recording on a per-printing device basis. In a related example, a process recorder activation plug-in or a printer driver can have a user interface to control whether or not to send commands in print jobs to instruct printing devices to enable process recording on a per-print job basis. Other techniques for remotely controlling process recording are possible as well.

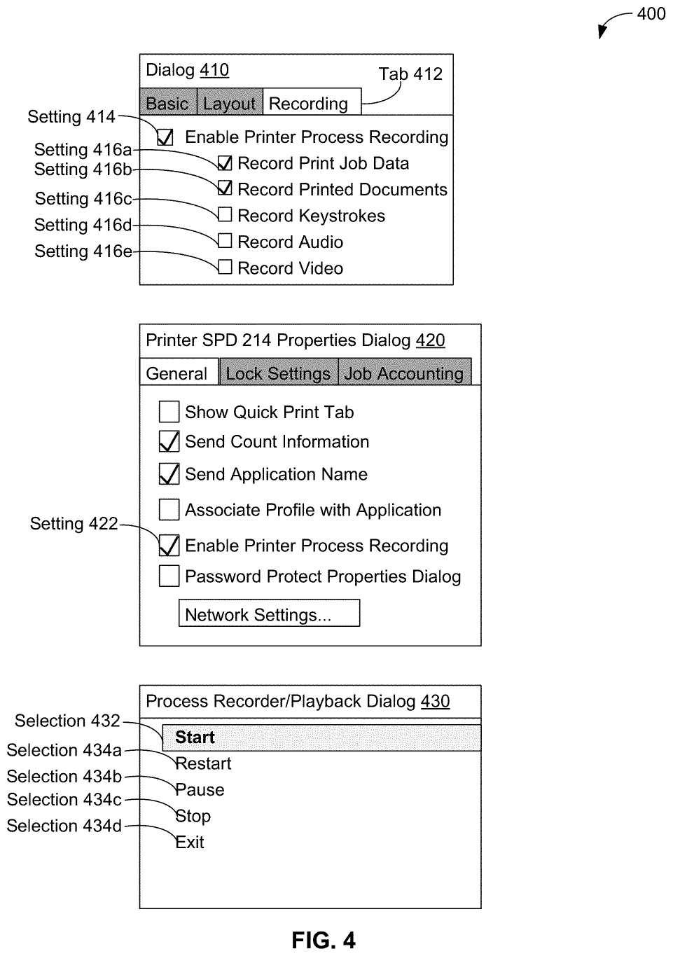

FIG. 4 shows diagram 400 that illustrates user interfaces related to process recording, in accordance with example embodiments. The user interfaces related to process recording shown in FIG. 4 are dialogs 410, 420, and 430. Each of dialogs 410, 420, and 430 are made up of elements. An element of a herein-described user interface, such as but not limited to dialogs 410, 420, 430, user interface 900, and/or user interface 1000, can be a feature of the user interface that can be used to receive input and/or provide output. Example elements of user interfaces include, but are not limited to, windows, dialogs, regions, displays, menus (including pull-down menus and system tray menus), icons, controls, buttons, keys, tabs, cursors, pointers, selection boxes, indicators, settings, check boxes, and selections. In other examples, more, fewer, and/or different elements and/or arrangements of elements can be used to provide the herein-described user interfaces.

Dialog 410 is a user interface that can be provided by computing device software, such as a software application or printer driver, to control process recording on a per-print job basis. For example, dialog 410 can include tab 412 with settings 414, 416a, 416b, 416c, 416d, 416e for controlling various aspects of process recording. In other examples, more, less, and/or different settings than settings 414 and 416a-416e and/or a different dialog than dialog 410 can be used to control aspects of process recording on at least a per-print job basis.

Setting 414, when enabled as indicated in FIG. 4 using a check mark, can enable process recording on a per-print job basis. When setting 414 is disabled, process recording is not enabled on a per-print job basis, but may still be enabled on another basis; e.g., enabled at a particular printer, enabled on a per-printer basis using a printer driver. For dialog 410, if setting 414 is enabled, settings 416a-416e can control various aspects of process recording. However, if setting 414 is disabled, settings 416a-416e can be ignored.

Setting 416a, when enabled as indicated in FIG. 4 using a check mark, can enable process recording of print job data on the device for the print job, and so print job data, such as, but not limited to, data about print job times, print job sizes, names of files printed by print jobs, sizes of files printed by print jobs, and print job commands, is recorded during process recording. If setting 416a is disabled, process recording of print job data on the device is disabled for the device, and so print job data is not recorded during process recording. In some examples, setting 416a can also, or instead, control whether an enable recording command related to a print job is sent to a printing device to instruct the printing device to activate process recording; i.e., when setting 416a is enabled, the enable recording command is sent for print jobs issued by the device, and when setting 416a is disabled, the enable recording command is not sent in print jobs issued by the device.

For example, the enable recording command can be: directly sent to a printing device, included in a job ticket that is sent with a print job, included in a job ticket that is sent separately from a print job, and/or included in a print job, whether prepended, embedded or appended. A job ticket with an enable recording command can be called a “process recording job ticket” and a print job with an enable recording command can be called a “process recording print job”. Then, when a printing device receives the enable recording command; e.g., in a process recording job ticket or process recording print job, the printing device can activate process recording on the printing device.

Setting 416b, when enabled as indicated in FIG. 4 using a check mark, can enable process recording of printed documents for the print job, and so a copy of each document, file, and/or other data printed as part of the print job is recorded during process recording. If setting 416b is disabled, process recording of printed documents is disabled for the device, and so copies of documents, files, and/or other data printed as part of the print job is not recorded during process recording.

Setting 416c, when enabled, can allow recording of data about keystrokes and/or related button presses on a device during process recording. If setting 416c is disabled, such as shown in FIG. 4 by the lack of a check mark in the box for setting 416c, recording of data about keystrokes and/or related button presses during process recording is disabled for the device, and data about keystrokes and/or related button presses is not recorded during process recording.

Setting 416d, when enabled, can allow recording of audio data for a device during process recording. If setting 416d is disabled, such as shown in FIG. 4 by the lack of a check mark in the box for setting 416d, recording of audio data for a device during process recording is disabled for the device, and so video data for the device is not recorded during process recording.

Setting 416e, when enabled, can allow recording of video data for a device during process recording. If setting 416e is disabled, such as shown in FIG. 4 by the lack of a check mark in the box for setting 416e, recording of video data for a device during process recording is disabled for the device, and so video data for the device is not recorded during process recording.

Dialog 420 is a user interface that can be provided a printer driver or other software to control process recording for on a per-printing device basis; in the example shown in FIG .4, the particular printing device is scanning/printing device 214. Among other settings, dialog 420 includes setting 422, where setting 422 is accessible selection of a “General” tab of dialog 420.

Setting 422, when enabled as indicated in FIG. 4 using a check mark, can enable process recording on a per-printing device basis. In the specific example shown in FIG. 4, dialog 420 indicates that setting 422 enables process recording on a per-printing device basis for a particular printing device; e.g., printing device “Printer SPD 214”, since dialog 420 is shown as a dialog for “Printer SPD 214 Properties”. When setting 422 is disabled, process recording is not enabled for the particular printing device; e.g., Printer SPD 214, on a per-printing device basis, but may still be enabled on another basis; e.g., enabled using settings of particular printing device, enabled on a per-print job basis. To enable process recording on a per-printing device basis, a device providing dialog 420 can send one or more enable recording commands to the particular printing device, can send one or more process recording job tickets to the particular printing device, and/or can send one or more process recording print jobs to the particular printing device. Other techniques to enable process recording on a per-printing device basis are possible as well.

Process recording and/or playback of data recorded during process recording can be provided using one or more user interfaces. Dialog 430 can be used to control process recording and/or playback of recorded event-related data, such as, but not limited to, one or more playbacks of one or more time-oriented sequences of events recorded during process recording. FIG. 4 shows that dialog 430 can include a menu of selections 432, 434a, 434b, 434c, and 434 to respectively start, restart, pause, stop, and exit process recording and/or playback of event-related data. In other examples, more, less, and/or different selections than selections 432, 434a, 434b, 434c, 434d and/or a different dialog than dialog 430 can be used to control aspects of process recording on at least a per-print job basis.

Selection 432, when selected as indicated in FIG. 4 using a bold font and a grey bar, can indicate that process recording and/or playback of recorded event-related data be initiated; that is, the playback should start. Once started, process recording and/or the playback of recorded event-related data can continue until dialog 430 and/or other user-interface elements are used to indicate that the playback should be paused, stopped, restarted, exited, or otherwise be modified.

Selections 434a, 434b, 434c, 434d, if selected, can respectively indicate that process recording and/or playback of recorded event-related data can be restarted, paused, stopped, or exited. In FIG. 4, none of selections 434a, 434b, 434c, 434d is selected as indicated by dialog 430 by using both a regular, non-bold font to display each of 434a, 434b, 434c, 434d and by presenting each of 434a, 434b, 434c, 434d without a grey bar (unlike selected selection 432).

When process recording and/or playback of recorded event-related data is restarted, the process recording and/or playback of recorded event-related data is reinitiated (or restarted) from a beginning of the recorded event-related data. When playback of recorded event-related data is paused, display/presentation of the playback of recorded event-related data is suspended (or paused) at a current position of the playback until the playback is either no longer suspended, restarted, stopped, or exited. In some examples, if a playback is paused, a computing device and/or a printing device associated with the playback can be paused as well.

A user of dialog 430 can indicate that process recording and/or playback is no longer to be suspended by selecting previously selecting selection 434b to toggle the pause selection to no longer being selected and/or by selecting selection 432 and/or selection 434a to indicate process recording and/or playback should start or restart and so process recording and/or playback should no longer be suspended. When process recording and/or playback of recorded event-related data is stopped, display and/or presentation of the playback ceases, or stops. When process recording and/or playback of recorded event-related data is exited, an application used for playback of recorded event-related data can be terminated or exited, causing the display and/or presentation of the playback to stop as well.

Some issues with a printing device can occur and/or be discovered when using scanning, printing, faxing, job storage, copying, and/or other functions of the printing device. These issues can be seen during receipt, processing, rendering, and/or finishing of a print job or other job. Some issues can be related to user or operator interaction with a printing device; e.g., interaction with front panel controls and/or buttons, interaction with covers, trays, and/or doors of the printing device. These interactions can lead to part or all of some issues with the printing device. Data related to these issues can be recorded using process recording.

Process recording can be activated (or deactivated) on different devices using one or more interfaces to process recording software, such as discussed above in the context of at least FIG. 3. For example, process recording can be activated (or deactivated) using a printer driver, such as printer driver 350. As another example, process recording can be activated (or deactivated) using a front panel of a printing device; e.g., using a “Process Record” (or similar) button of the Front Panel.

In some scenarios, after activating process recording, a user would perform “steps to reproduce” to reproduce a problem or issue with the printing device. Such steps to reproduce can include, but are not limited to, interacting and changing settings in the printer, manipulating hardware of the printing device (e.g., opening/closing doors, trays, covers, etc.), and utilizing scanning, faxing, printing, and/or other printing device features.

When activated, the process recording software can capture event-related data as part of process recording and generate one or more process recording data files, or just “data files” for short, that include the captured event-related data. The data files can be retrieved, saved, copied, communicated, etc. like other files. For example, during process recording, event-related data related to a particular issue can be captured at a printing device in a data file named “DF1”. Then, data file DF1 can be transmitted from the printing device to a manufacturer of the printing device, so that the particular issue can be resolved. Retrieval, saving, copying, transmission etc. of data files can occur at any time after process recording has been enabled; e.g., after the steps to reproduce have been carried out.

In some examples, a playback can provide instructions related to steps to reproduce. If an instruction related to a step to reproduce is not followed, playback can be restarted; i.e., deviation of steps to reproduce can cause playback of previously recorded data to be inaccurate and so the playback can be restarted. If an instruction related to a step to reproduce is not followed, a warning message can be provided indicating that a step to reproduce was not followed and that playback is to be restarted.

Process recording can involve recording events at a printing device and/or at a computing device that is not a printing device. Process recording can occur at the computing device since printer-related problems/issues can arise due to events that occur at the computing device; e.g., events related to a document editing application, events related to printer settings set using the computing device, events related to documents queued by the computing device at a printer spooler. Thus, events that occur at the computing device can be recorded using process recording software; i.e., to provide a full understanding about how a document at the computing device for an erroneous print job was created, how the document was prepared for printing by the computing device, how a printer driver of the computing device created the erroneous print job, and how the computing device sent the erroneous print job to the printing device.

The type of data to be captured during process recording can be configurable as discussed at least in the context of dialog 410. In some examples, a user interface, such as dialog 410, can provide user control over what data (i.e., identifying attributes), how much of the data (i.e., quantity), and how frequently the data will be captured or gathered (i.e., timing) during process recording.

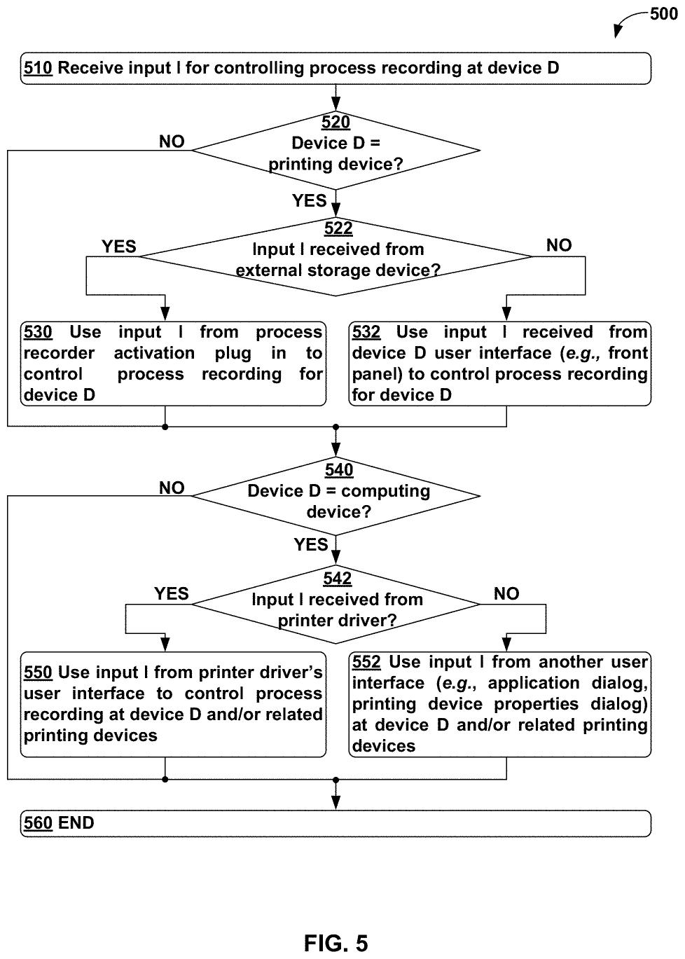

FIG. 5 is a flowchart for method 500 for controlling process recording activities in accordance with example embodiments. In particular, method 500 illustrates examples of how process recording activities can be controlled at printing devices and computing devices, such as scanning/printing devices 214, 216 and computing device 220 discussed at least in the context of FIG. 3. Method 500 can be carried out by a computing device, such as computing device 100. In FIG. 5, the computing device is termed device D, and the computing device will be termed device D below.

Method 500 can begin at block 510, where device D can receive input I to control process recording at device D. Input Ito control process recording can include, but is not limited to, input related to activation of process recording, input related to deactivation of process recording, and input related to features of process recording (e.g., input parameters, controls for recording or not recording one or more types of information).

At block 520, device D can determine whether device D is a printing device. If device D is a printing device, then device D can proceed to block 522. Otherwise, device D can determine that device D is not a printing device, and device D can proceed to block 540.

Based on the determination made at block 520 and the flowchart depicting method 500, device D can be determined to be a printing device at blocks 522, 530, and 532.

At block 522, printing device D can determine whether input I was received from an external storage device; e.g., input I received from process recorder activation plug-in 312 of external storage device 310. If printing device D determines that input I was received from an external storage device, then printing device D can proceed to block 530. Otherwise, printing device D can determine that input I was not received from an external storage device and proceed to block 532.

At block 530, printing device D can receive input I to control process recording at device D from the external storage device; e.g., from a plug-in such as process recorder activation plug-in 312 of external storage device 310. After completing the procedures of block 530, printing device D can proceed to block 540.

At block 532, printing device D can receive input I to control process recording at device D from a user interface of device D; e.g., a front panel or other user interface.

At block 540, device D can determine whether device D is a computing device. If device D is a computing device, then device D can proceed to block 542. Otherwise, device D can determine that device D is not a computing device, and device D can proceed to block 560.

Based on the determination made at block 540 and the flowchart depicting method 500, device D can be determined to be a computing device at blocks 542, 550, and 552. At block 542, computing device D can determine whether input I was received from a printer driver; i.e., as opposed to being received from a printer driver. If computing device D determines that input I was received from a, then printing device D can proceed to block 530. Otherwise, printing device D can determine that input I was not received from an external storage device and proceed to block 532.

At block 550, computing device D can use input I provided by a user interface of the printer driver; e.g., dialog 410 or dialog 420, to control process recording activities at computing device D and/or related printing devices; e.g., to control process recording activities at a printing device made accessible using the printer driver. After completing the procedures of block 550, computing device D can proceed to block 560.

At block 552, computing device D can use input I provided by another source than the printer driver, such as a software application, to control process recording activities at computing device D and/or related printing devices; e.g., a printing device used to print a document associated with a software application. Input I can be provided using a user interfaced of the other source; e.g., dialog 410 or 420.

At block 560, method 500 can end. In other examples, at block 560, device D can await additional input related to controlling process recording activities; then, when that additional input is available, device D can proceed to block 510 to receive that additional input.

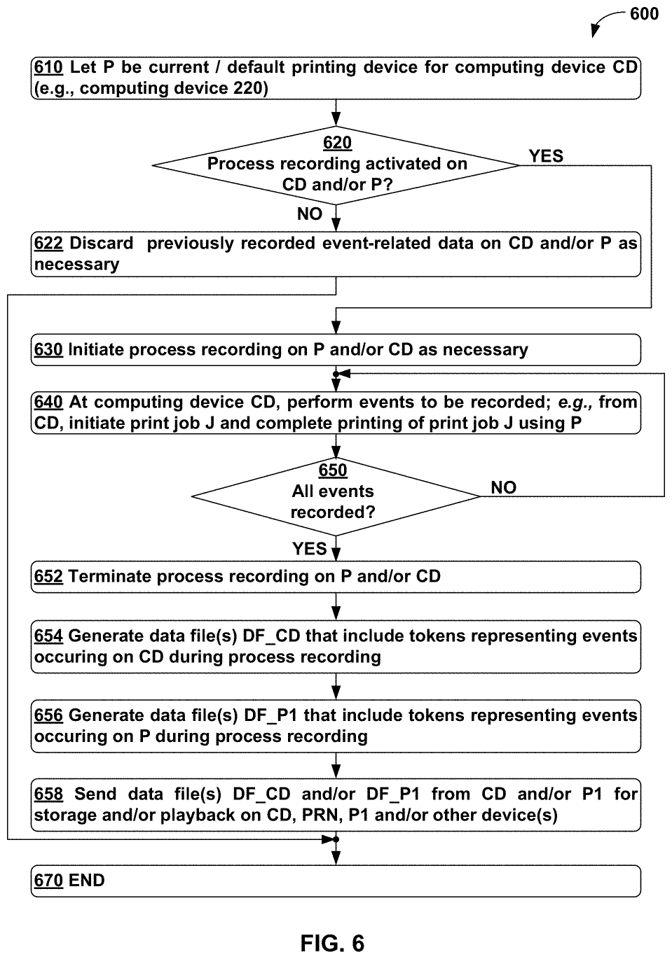

FIG. 6 is a flowchart for method 600 for performing process recording, in accordance with example embodiments. Method 600 can be carried out by a computing device, such as computing device 100. In FIG. 6, the computing device is termed computing device CD, and the computing device will be termed computing device CD below.

In the example described in the context of method 600, two devices—computing device CD and printing device P—are involved in process recording. In other related examples, more, fewer, and/or different devices can be involved in process recording; e.g., process recording can be carried out on multiple computing devices and/or on multiple printing devices; process recording can be carried out only on one device (a printing device or a computing device). One of skill in the art would readily recognize how to adapt method 600 to the other related scenarios based on the teachings disclosed herein.

Method 600 can begin at block 610, where computing device CD can let printing device P be a current and/or default printing device for computing device CD.

At block 620, computing device CD can determine whether process recording is activated on computing device CD and/or on printing device P. If computing device CD determines that process recording is activated on computing device CD and/or on printing device P, computing device CD can proceed to block 630. Otherwise, computing device CD can determine that process recording is not activated on either computing device CD or printing device P, and can proceed to block 622.

At block 622, computing device CD can discard previously recorded event-related data/data previously recorded during process recording on computing device CD and/or on printing device P. In some examples, printing device can perform part or all of the procedures of block 622; e.g., printing device P can discard previously recorded event-related data/data previously recorded during process recording on printing device P. In some examples, previously recorded event-related data is not deleted except in response to a specific command to delete the previously recorded event-related data. In some examples, computing device CD can determine that process recording is not activated on either computing device CD or printing device P at block 620, and can proceed to block 630, thereby omitting the procedures of block 622.

At block 630, computing device CD can initiate process recording on printing device P and/or on CD as necessary; i.e., initiate process recording on P and/or CD if not already initiated on one or both devices. In some examples, printing device can perform part or all of the procedures of block 630; e.g., printing device P can initiate process recording on printing device P.

At block 640, computing device CD can perform events to be recorded using process recording; e.g., these events can include steps to reproduce an issue with printing device P. For example, at block 640, computing device CD can attempt to initiate print job J and printing device P can attempt to receive and process print job J.

At block 650, computing device CD can determine whether all events to be recorded using process recording have been recorded. For example, computing device CD can receive a command or other input indicating that process recording is to be terminated and therefore infer that all events to be recorded using process recording have been recorded. If computing device CD can determine that all events to be recorded using process recording have been recorded, computing device CD can proceed to block 652. Otherwise, computing device CD can determine that all events to be recorded using process recording have not been recorded and computing device CD can proceed to block 640.

At block 652, computing device CD can terminate process recording on computing device CD and/or printing device P.

At block 654, computing device CD can generate one or more data files DF_CD with tokens representing events that occurred on computing device CD during process recording. That is, one token generated from data file(s) DF_CD can represent part or all of an event that occurred on computing device CD and recorded during process recording. Further, a group of tokens generated from data file(s) DF_CD that have been organized in time order can represent a time-oriented sequence of events that occurred on computing device CD and were recorded during process recording.

At block 656, computing device CD can generate one or more data files DF_P1 with tokens representing events that occurred on printing device P during process recording. That is, one token generated from data file(s) DF_P1 can represent part or all of an event that occurred on printing device P and recorded during process recording. Further, a group of tokens generated from data file(s) DF_P1 that have been organized in time order can represent a time-oriented sequence of events that occurred on printing device P and were recorded during process recording.

For example, at blocks 654 and/or 656, data recorded during process recording can be tokenized, or otherwise converted, into tokens. The tokens can be associated with related data. The tokens can include, but are not limited to:
A token indicating a beginning of a process recording file;
A token indicating an end of a process recording file;
A token indicating an event where a printing device process was started;
A token indicating an event where a printing device process was ended;
A token indicating an event where a print job was created;
A token indicating an event where a print job was sent to a printing device and/or a related device; e.g., a print server, a print spooling device, etc.;
A token indicating an event where a print job was received at a printing device and/or a related device;
A token indicating an event where a print job was unsuccessfully completed at a printing device and/or a related device;
A token indicating an event where a portion of a print job was completed at a printing device and/or a related device; e.g., one or more pages were printed, one copy of a print job involving printing of multiple copies of a document was printed;
A token indicating an event where a print job was successfully completed at a printing device and/or a related device;
A token indicating an event related to a sub-device of a printing device occurred; e.g., movement of: a door of the printing device, a tray of the printing device, a lever of the printing device, a cover of the printing device, a front panel of the printing device, and/or a control panel of the printing device, a sub-device sticking, a sub-device failing, a sub-device being diagnosed.
A token indicating a user interface event occurred; e.g., a button was pressed on a front panel of a printing device, data was displayed on the front panel, a notification about completion of a print job was sent and/or displayed.

Related data for a token can include, but is not limited to:
Timing data; e.g., a time stamp when an event occurred that is recorded in the data file by the token and related data;
Device identification data; e.g., one or more identifiers for computing device CD and/or printing device P that recorded an event now recorded in the data file by the token and related data;
Sub-device identification data; e.g. one or more identifiers for sub-devices of computing device CD and/or printing device P, such as trays, doors, covers, etc. associated with an event recorded by the token and related data;
Print job identification data; e.g., one or more print job names, numbers, and/or other identifiers, one or more document names, numbers, and/or other identifiers being printed or otherwise processed during a print job associated with an event recorded by the token and related data;
User input data indicating input received from a user interface associated with an event recorded by the token and related data; and
User output data indicating output provided to a user interface associated with an event recorded by the token and related data.

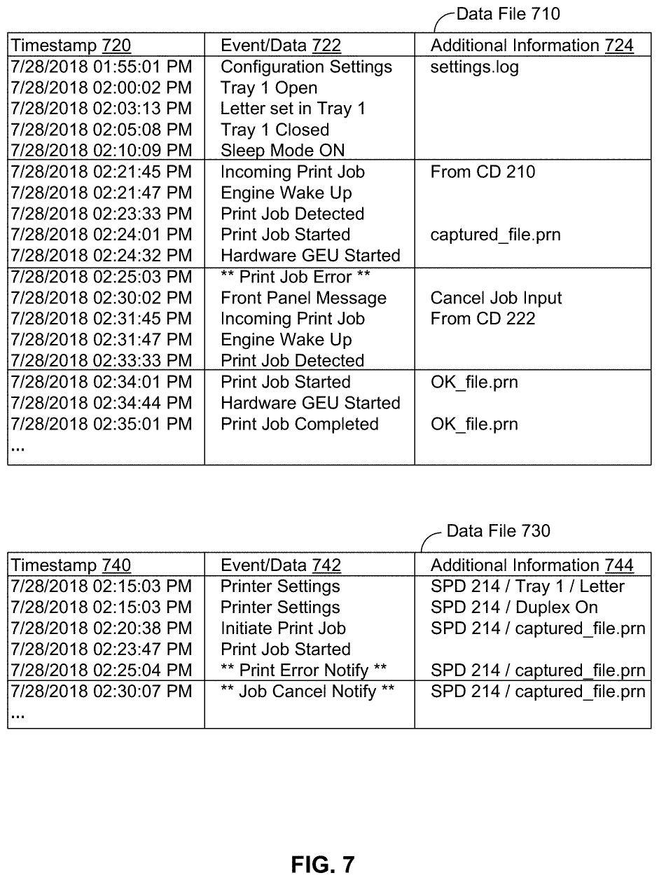

FIG. 7 shows data files 710, 730 related to events recorded during process recording. Each of data files 710, 730 can be useful in diagnosing and verifying problems in printing devices and/or computing devices. More particularly, data file 710 shows data recorded for events occurring at a printing device; e.g., printing device P of method 600. Data file 730 shows event-related data recorded for events occurring at a computing device; e.g., computing device CD of method 600. A data file, such as data file 710 and/or data file 730, can be formatted using one or more formats, such as, but not limited to, a format based on WL, a text format, and/or a comma-separated value (CSV) format. In some examples, a data file can be provided as a data stream and/or as an electronic file.

The depictions of data files 710, 730 shown in FIG. 7 are examples of what may be seen as a report or playback of data, such as event-related data, stored in data files 710, 730. In other examples, data, such as event-related data, stored in data files 710, 730 can be displayed by a user interface (e.g., a GUI) of a printing device and/or computing device and/or a connected device such as mobile phone, tablet, or other computing device.

Each of data files 710, 730 includes a number of data file records, with each record having three fields. In other examples, data file 710 and/or data file 730 can have more, fewer, and/or different records and/or more, fewer, and/or different fields. In FIG. 7, records are shown as rows of each of data file 710 and data file 730, and fields are shown as columns of each of data file 710 and data file 730. The three fields of data file 710 are shown as timestamp 720, event/data 722, and additional information 724. Similarly, three fields of data file 730 are shown as timestamp 740, event/data 742, and additional information 744.

Event/data fields of data files 710 and 730 can represent tokens for each data file. For example, event/data field 722 of data file 710 includes tokens related to a printing device that include “Configuration Settings”, “Tray 1 Open”, “Letter set in Tray 1”, “Tray 1 closed”, “Sleep Mode ON”, among others. In a related example, event/data field 742 of data file 730 includes tokens related to a computing device that include “Printer Settings”, “Initiate Print Job”, “Print Job Started, “**Print Error Notify**”, and “**Job Cancel Notify**”.

Timestamps and additional information fields of data files 710 and 730 can represent related data to the tokens for each data file. For example, timestamp field 720 of data file 710 can record timing information about when an event indicated with a token in event/data field 722 was recorded and additional information field 724 can provide further data about the event that was recorded. For example, a first row of data file 710 shows timestamp field 720 indicating that data related to “Configuration Settings” token was recorded at a time “7/28/2018 01:55:01 PM” for a printing device, and additional information field 724 for that token had related data recorded as “settings.log”; i.e., indicating that additional information about the configuration settings can be found in a file called “settings.log”.

As another example, timestamp field 740 of data file 730 can record timing information about when an event indicated with a token in in event/data field 742 was recorded and additional information field 744 can provide further data about the event that was recorded. For example, a first row of data file 730 shows timestamp field 740 indicating that data related to “Printer Settings” token was recorded at a time “7/28/2018 02:15:03 PM” for a computing device, and additional information field 724 for that token had related data recorded as “SPD 214/Tray 1/Letter”; i.e., indicating that printer settings were for a “Tray 1” of a printing device “SPD 214” to indicate the tray holds “Letter” type paper.

Many other examples are possible as well. In other examples, tokens of data files 710 and/or 730 can differ from those shown in FIG. 7. For example, tokens can be represented by numbers or other sequentially organized symbols (e.g., letters, sequentially organized alpha-numeric labels). In such examples, a jump table, lookup table, or similar data structure can use the (numerical/sequentially-symbolic) token as an index to locate a function (or functions) to process the token; e.g., to playback an event recorded using the token. In related examples, the (numerical/sequentially-symbolic) token can be used in a switch statement or similar code structure to process the token. In other related examples, the tokens can be converted to numbers or other sequentially organized symbols, and those numbers/sequential symbols can be used to process the token.

Returning to FIG. 6, at block 658, computing device CD can send one or more of data file(s) DF_CD and DF_P1 to one or more other devices for storage and/or playback. The other devices can include, but are not limited to, one or more computing devices and/or one or more printing devices; e.g., a process recorder node or nodes of process recorder node(s) 230, a computing device or devices of distributed storage system 232. In some examples, printing device P can store some or all of data file(s) DF_CD and DF_P1; in these examples, printing device P can send one or more of data file(s) DF_CD and DF_P1 to one or more other devices for storage and/or playback.

At block 670, method 600 can end.

Data stored by process recording, e.g., data files DF_CD and/or DF_P1 generated by method 600, can be played back; e.g., using one or more playback components of process recorder and playback software 330a, process recorder and playback software 330b, and/or process recorder software 354

The playback component can provide a playback of data recorded during process recording by parsing the data recorded during process recording, generating a presentation of the parsed data, and displaying and/or otherwise providing the presentation of parsed data. Parsing the data recorded during process recording can involve examining the data recorded during process recording for one or more tokens and/or generating the one or more tokens from the data recorded during process recording. Then, the playback component can process the token(s) to generate the presentation of the parsed data and provide the generated presentation.

For example, suppose a token T1 in data recorded during process recording relates to a print job. Then, the playback component can process token T1 to timestamp a print job X received at that time, extract data related to print job X from the data recorded during process recording, and generate a presentation of the data related to print job X. As another example, suppose a token T2 in data recorded during process recording relates to a button press of a front panel of a printing device. Then, the playback component can process token T2 to timestamp the button press, extract data related to the button press from the data recorded during process recording, and generate a presentation of the data related to the button press. In some examples, the playback component can save a presentation of the data in a format used for data files 710, 730 that includes tokens related to events/data, timestamps, and additional information, as discussed at least in the context of FIG. 7.

In some examples, the playback component can save a presentation of the data in another format; e.g., in a word-processing format, in a spreadsheet format, in a slide presentation format, in a page description language format, and/or in one or more other formats. In some examples, the playback component can provide the presentation of parsed data using a graphical user interface and/or another user interface of a printing device (e.g., on a front panel) and/or one or more graphical user interfaces of one or more computing devices; e.g., one or more tablets, laptops, desktops, mobile devices, other computing devices.

In some examples, the playback component can generate, save, and/or provide a simulation of a time-oriented sequence of events that were recorded during process recording. The playback component can parse the data recorded during process recording; then, the playback component can perform and/or simulate print jobs, front panel events, tray events, and/or other events recorded during process recording in an order as captured; that is, in a time sequence that is related to an order in which data for events were recorded in a data file/data recorded during process recording. For events involving user intervention, the playback component can display on a front panel or other user interface to guide a user on how to perform one or more events involving user intervention' e.g., which buttons to press on a front panel, which printing device doors, covers, and/or trays to open or close, which printer levers to raise, lower and/or otherwise move.

The playback component can generate a simulation of a time-oriented sequence of events. The simulation can include an indication of which specific event (or events) of the time-oriented sequence of events is being displayed/presented at any given time during the simulation. For example, the indication of the specific event can include highlighting of the specific event on a user interface; such as a simulated or actual front panel display. The indication can be a full-screen display, a partial-screen display, and/or a transparent display. The indication can include effects emphasizing a user interface element associated with the specific event; e.g., a selected button can glow/use different lighting and/or can be shown with a different icon, color, and/or shape.

In some examples, the simulation can include a simulation of a sub-device being moved and/or an indication to move a sub-device; e.g., movement of: a door of the printing device, a tray of the printing device, a lever of the printing device, a cover of the printing device, and/or a control panel of the printing device. In some of these examples, operations of a device are paused until the sub-device is moved as indicated in the simulation; e.g., printing of a printing device is paused until a lever is moved up or down as indicated in the simulation.

In some examples, the playback component can cause an actual replay of the time-oriented sequence of events. For example, if the time-oriented sequence of events including sending print job JOB1 to printing device PRT1, then the playback component can extract JOB1 from the data stored during process recording and send JOB1 to PRT1, where PRT1 will carry out print job JOB1. In some of these examples, a printing device and/or a computing device can carry out at least part of the time-oriented sequence of events during the actual replay; then, at least some user-interface, device, and sub-device operations can occur during the actual replay the same as when recorded during process recording; e.g., displays/notifications can be displayed, light emitting diodes can blink/flash, paper can be fed and printed by a printing device, etc. Then, if a problem happens during actual replay, such as a device crashing or a process begin abnormally terminated, a computing device and/or a printing device can show animations and/or messages warning about the problem and/or indicating that the problem occurred.

In some examples, process recording software can indicate that a problem has been reproduced during playback; i.e., to help assist in the diagnosis and finding of a solution of the problem. In some examples, the process recording software can indicate that a problem has been reproduced during or after during the occurrence of the problem that is being reproduced/replicated. In an example of a problem involving a severe or fatal error (e.g. a system crash or hanging process), the process recording software can provide a message or other indication that the severe or fatal error occurred and was expected as part of playback—this message/indication can indicate the error was expected during playback rather than being unexpected. In some embodiments, the process recording software can include a system level service that can execute a software interrupt to produce the message/indication of an expected error. In some examples, the process recording software can provide a message or other indication that an expected error is about to occur; e.g., provide an alert message prior to an expected error. In some examples, the process recording software can issue the alert message prior to an expected error and pause a computing device and/or a printing device just before the expected error actually occurs. While paused, the process recording software can request input to either continue the playback or to stop the playback. If the input indicates continue with the playback, the expected error could occur and could cause a severe and/or fatal error.

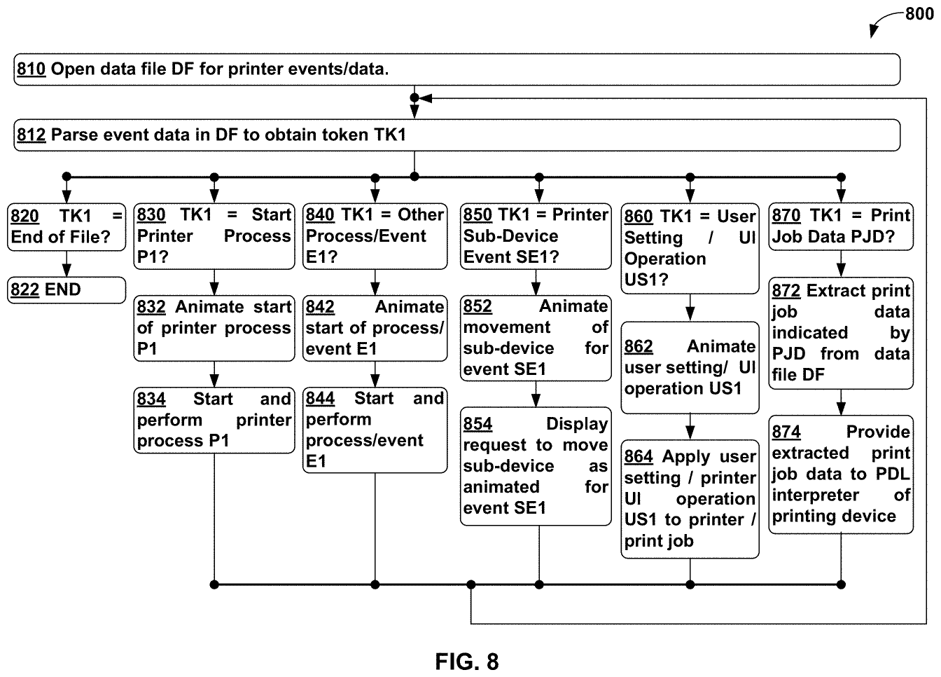

FIG. 8 is a flowchart for method 800 for playing back data recorded for printing devices, in accordance with example embodiments. Method 800 can be carried out by a computing device, such as computing device 100.

Method 800 can begin at block 810, where the computing device can open a data file DF, where data file DF stores event-related data obtained using the herein-described process recording techniques. In some examples, the computing device can open multiple data files at block 810

At block 812, the computing device can parse or otherwise determine a token TK from data file DF. In some examples, the computing device can parse data from data file DF to determine token TK. In some examples, token TK can be recorded in data file DF, and so token TK can be obtained from data file DF without explicitly parsing data from data file DF. In some examples, the computing device can parse data file DF and/or otherwise determine multiple tokens TK at block 812. Other techniques to parse, determine, and/or otherwise obtain token(s) TK are possible as well.

At block 820, the computing device can determine whether token TK is an end-of-file token. If token TK is an end-of-file token, the computing device can proceed to block 822. Otherwise, the computing device can determine that token TK is not an end of file token, and can proceed to block 830.

At block 822, method 800 can end.

At block 830, the computing device can determine whether token TK is a start-printer-process token representing starting a printer process P1 of the printing device. Printer process P1 can be a process, thread, or other similar structure than can perform part or all of a print job and/or can perform some other functionality of the printing device. If token TK is a start-printer-process token, the computing device can proceed to block 832. Otherwise, the computing device can determine that token TK is not a start-printer-process token, and can proceed to block 840. In some examples, a start-printer-process token can represent starting one or more other types of events than starting processes on a printing device.

At block 832, the computing device can animate and/or otherwise indicate starting of printer process P1.

At block 834, the computing device can start and perform functionality of printer process P 1, either directly (e.g., starting and performing printing process P1 if the computing device is the printing device for printer process P1) or indirectly (e.g., sending a command or otherwise indicate to the printing device for printer process P1 to start and perform printer process P1 if the computing device is not the printing device for printer process P1). Examples of process P1 include, but are not limited to: a color registration process, a color calibration process, a factory reset process, a memory initialization process, a disk-related process, and/or a profiling process. Upon completion of the procedures of block 834, the computing device can proceed to block 812.

At block 840, the computing device can determine whether token TK is an other-process token representing starting a process or event E1 on another device than a printing device. If token TK is an other-process token, the computing device can proceed to block 842. Otherwise, the computing device can determine that token TK is not an other-process token, and can proceed to block 850.

At block 842, the computing device can animate and/or otherwise indicate starting of process or event E1.

At block 844, the computing device can start and perform functionality of process or event E1, either directly (e.g., starting and performing process or event E1 if the computing device is the device other than a printing device associated with process or event E1 mentioned at block 840) or indirectly (e.g., sending a command or otherwise indicate to the device other than a printing device associated with process or event E1 mentioned at block 840 to start and perform process or event E1 if the computing device is not the device other than a printing device associated with process or event E1). Upon completion of the procedures of block 844, the computing device can proceed to block 812.

At block 850, the computing device can determine whether token TK is a printer-sub-device-event token representing an event SE1 related to a sub-device of a printing device. If token TK is a printer-sub-device-event token, the computing device can proceed to block 852. Otherwise, the computing device can determine that token TK is not a printer-sub-device-event token, and can proceed to block 860.

At block 852, the computing device can animate and/or otherwise indicate information about movement of the sub-device and/or other information (e.g., status information, diagnostic information) about the sub-device of the printing device mentioned at block 850.

At block 854, the computing device can display a request to move the sub-device of the printing device mentioned at block 850 as necessary as indicated by the animation/indication provided at block 852. Then, the sub-device of the printing device can be moved as requested (e.g., by a user of the printing device). Upon completion of the procedures of block 854, the computing device can proceed to block 812.

At block 860, the computing device can determine whether token TK is a user-setting token representing an event US1 related to using a user interface to add, delete, update, and/or review data related to one or more settings of a device and/or to perform another user interface operation on the device. For example, event US1 can be an event related to: receiving data using a user interface of the printing device and/or a user interface of the computing device, providing data using the user interface of the printing device and/or the user interface of the computing device, activating an element (such as a key or button) of the user interface of the printing device and/or the user interface of the computing device, enabling an element (such as a key or button) of the user interface of the printing device and/or the user interface of the computing device, and/or disabling an element (such as a key or button) of the user interface of the printing device and/or the user interface of the computing device.

If token TK is a user-setting token, the computing device can proceed to block 862. Otherwise, the computing device can determine that token TK is not a user-setting token, and can proceed to block 870.

At block 862, the computing device can provide an animation and/or otherwise indicate the event US1 related to using a user interface for settings of a device and/or related to another user interface operation on the device.

At block 864, the computing device can apply the settings of a device and/or perform the user interface operation on the device either directly (i.e., if the computing device is the device mentioned at block 860) or indirectly (e.g., sending a command or otherwise indicate to the device mentioned at block 860 to apply the settings and/or perform the user interface operation on the device mentioned at block 860). Upon completion of the procedures of block 864, the computing device can proceed to block 812.

At block 870, the computing device can determine whether token TK is a print-job token representing an event PJD related to a print job and/or data related to a print job. If token TK is a print-job token, the computing device can proceed to block 872. Otherwise, the computing device can determine that token TK is not a print-job token, and determine token TK is an erroneous token and discard token TK. In some examples, if token TK is not a print-job token, the computing device can: print an error message indicating token TK is an unexpected token or other error message, add token TK to a log of unexpected tokens, and/or end method 800.

At block 872, the computing device can extract the print job and/or data related to a print job from data file DF.

At block 874, the computing device can provide the extracted the print job and/or data related to a print job to a printing device; e.g., to a PDL interpreter of the printing device, to process the extracted print job and/or data related to a print job. Upon completion of the procedures of block 874, the computing device can proceed to block 812.

In some examples, more, fewer, and/or other tokens than end-of-file tokens, start-printer-process tokens, other-process tokens, printer-sub-device-event tokens, user-setting tokens, and print-job token can be processed using suitable modifications of method 800.

In some examples, method 800 is performed sequentially and/or synchronously, while in other examples, method 800 is performed in parallel and/or asynchronously. Performing method 800 in parallel and/or asynchronously may be able to improve performance in comparison to sequential/synchronous embodiments, especially when method 800 is carried out by a printing device that allows for almost instantaneous messaging, animation, and processing of token data and events by the printing device. For example, token parsing (or otherwise being determined) at block 812 can occur in parallel with the token processing using the procedures of blocks 820 through 874, after the procedures of block 812 have created multiple tokens to be processed. As another example, a token TK can be represented by numbers or other sequentially organized symbols (e.g., letters, sequentially organized alpha-numeric labels). In such examples, the procedures of blocks 820 through 874 can be implemented using token TK as an index into a jump table, lookup table, or similar data structure; then, the contents of the jump table, lookup table, or similar data structure indexed by token TK can be a function pointer or other data/technique that provides, identifies, and/or otherwise determine a procedure to process token TK. Other techniques for implementing method 800 are possible as well.

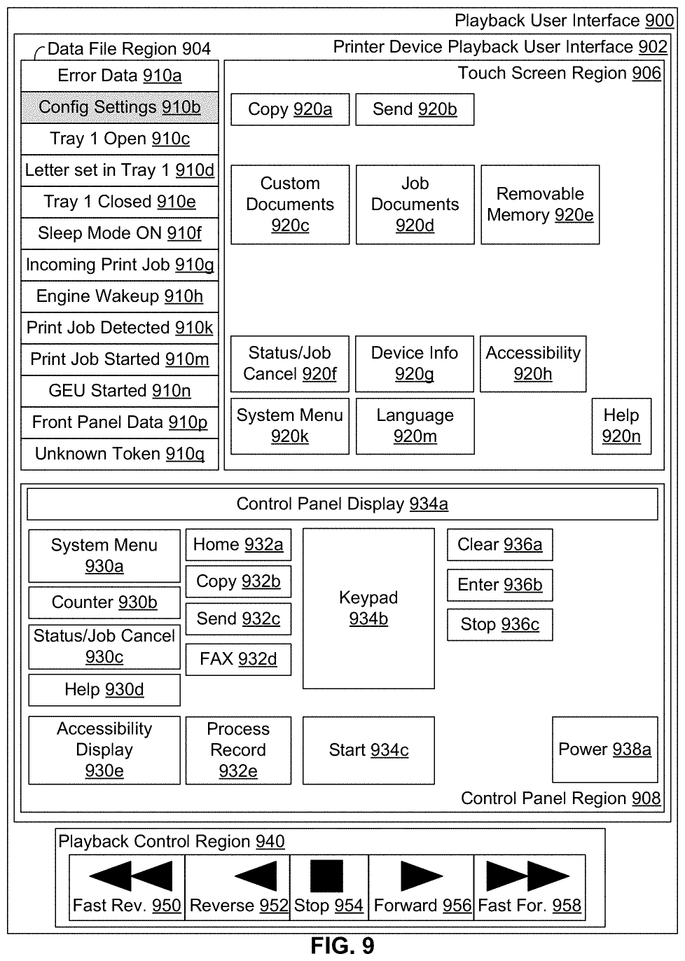

FIG. 9 illustrates user interface 900 for playing back data recorded during process recording, in accordance with example embodiments. Playback user interface 900 includes printer device playback user interface 902 and playback control region 940. Playback user interface 900, printer device playback user interface 902, and playback control region 940 can be used to playback, control, and/or otherwise interact with one or more printing devices, process recording software, and/or data files of data captured during process recording associated with the one or more printing devices.

Printer device playback user interface 902 can be used to playback and/or otherwise interact with a printing device, process recording software, and/or data files of data captured during process recording associated with the printing device. FIG. 9 shows that printer device playback user interface 902 includes data file region 904, touch screen region 906, and control panel region 908. In other examples, printer device playback user interface 902 can include more, fewer, and/or different regions than discussed herein.

Data file region 904 can include one or more indicators or other elements related to data and/or tokens associated with process recording software and/or data files of data captured during process recording, where the data and/or tokens (and consequently the indicators) are associated with the printing device. The indicators can include error data indicator 910a, configuration settings indicator 910b, tray 1 open indicator 910c, paper set in tray 1 indicator 910d, tray 1 closed indicator 910e, sleep mode on indicator 910f, incoming print job indicator 910g, engine wakeup indicator 910h, print job detected indicator 910k, print job started indicator 910m, graphics engine unit (GEU) started indicator 910n, front panel data indicator 910p, and unknown token indicator 910q. In other examples, data file region 904 can include more, fewer, and/or different indicators than discussed herein.

Error data indicator 910a can indicate that a token associated with erroneous data; e.g., erroneous data in a data file, erroneous data in a print job, etc. has been processed by printer device playback user interface 902. Configuration settings indicator 910b can indicate that a token associated with configuration data of the printing device has been processed by printer device playback user interface 902. The token associated with configuration data of the printing device can indicate that an event related to configuration data of the printing device has occurred; e.g., an event related to: setting a configuration setting (or other data) of the configuration data of the printing device, resetting a configuration setting (or other data) of the configuration data of the printing device, reviewing a configuration setting (or other data) of the configuration data of the printing device, modifying a configuration setting (or other data) of the configuration data of the printing device, adding a configuration setting (or other data) of the configuration data of the printing device, and/or deleting a configuration setting (or other data) of the configuration data of the printing device. Examples of configuration data for a printing device include, but are not limited to, settings related to a print job (or other procedure) associated with the printing device, data about a printer engine of the printing device, printer firmware version(s) for the printing device, front panel configuration data for the printing device, and feature and option settings for the printing device.

Tray 1 open indicator 910c can indicate that a token associated with a tray (e.g., Tray 1) of the printing device being opened has been processed by printer device playback user interface 902. In other examples, indicator 910c can indicate that a token associated with a tray of the printing device other than tray 1 being opened has been processed by printer device playback user interface 902. Paper set in tray 1 indicator 910d can indicate that a token associated with paper being placed (or loaded) into a tray (e.g., Tray 1) of the printing device has been processed by printer device playback user interface 902. In other examples, indicator 910d can indicate that a token associated with paper being placed into a tray other than tray 1 has been processed by printer device playback user interface 902. Tray 1 closed indicator 910e can indicate that a token associated with a tray (e.g., Tray 1) of the printing device being closed has been processed by printer device playback user interface 902. In other examples, indicator 910e can indicate that a token associated with a tray of the printing device other than tray 1 being closed has been processed by printer device playback user interface 902.

Sleep mode on indicator 910f can indicate that a token associated with putting the printing device into a sleep mode has been processed by printer device playback user interface 902. In other examples, indicator 910f can indicate that a token associated with removing the printing device from sleep mode has been processed by printer device playback user interface 902.

Incoming print job indicator 910g can indicate that a token associated with a print job being received at the printing device has been processed by printer device playback user interface 902. Engine wakeup indicator 910h can indicate that a token associated with starting (or waking up) a printer engine of the printing device has been processed by printer device playback user interface 902. In other examples, indicator 910h can indicate that a token associated with shutting down the printer engine (or putting the printer engine to sleep) has been processed by printer device playback user interface 902. Print job detected indicator 910k can indicate that a token associated with a print job being detected, but perhaps not yet received, by the printing device has been processed by printer device playback user interface 902.

Print job started indicator 910m can indicate that a token associated with a print job being started at the printing device has been processed by printer device playback user interface 902. In other examples, indicator 910g, indicator 910k, and./or indicator 910m can indicate that a token associated with a print job being completed has been processed by printer device playback user interface 902. Graphics engine unit (GEU) started indicator 910n can indicate that a token associated with starting a GEU of the printing device has been processed by printer device playback user interface 902. In other examples, indicator 910n can indicate that a token associated with shutting down the GEU of the printing device has been processed by printer device playback user interface 902.

Front panel data indicator 910p can indicate that a token associated with a user interface operation of the printing device (e.g., an operation of receiving input from and/or providing output to a front panel, control panel, and/or other user interface of the printing device) has been processed by printer device playback user interface 902. Unknown token indicator 910q can indicate that an unknown token, which is other than a token associated with one or more of indicators 910a, 910b, 910c, 910d, 910e, 910f, 910g, 910h, 910k, 910m, 910n, and 910p has been processed by printer device playback user interface 902.

Table 1 below shows an example mapping of the tokens mentioned in the context of method 800 to the tokens mentioned above in the context of printer device playback user interface 902:

TABLE 1

| | Corresponding token(s) of data file |
|---|---|
| Token of method 800 | region 904 |
| End-of-file token | Not illustrated in data file region 904 |
| associated with | |
| block 820 | |
| Start-printer-process | A token associated with starting (or waking |
| token associated with | up) a printer engine of the printing device |
| block 830 | associated with indicator 910h, a token |
| | associated with starting a GEU of the printing |
| | device associated with indicator 910n |
| Other-process token | A token associated with erroneous data |
| associated with | associated with indicator 910a, a token |
| block 840 | associated with putting the printing device |
| | into a sleep mode associated with indicator |
| | 910f, |
| Printer-sub-device-event | A token associated with a tray of the printing |
| token associated with | device being opened associated with indicator |
| block 850 | 910c, a token associated with paper being |
| | placed into a tray of the printing device |
| | associated with indicator 910d, a token |
| | associated with a tray of the printing device |
| | being closed associated with indicator 910e, |
| User-setting token | A token associated with configuration data |
| associated with | of the printing device associated with indicator |
| block 860 | 910b, a token associated with a user interface |
| | operation of the printing device associated |
| | with indicator 910p |
| Print-job token | A token associated with a print job being |
| associated with | received at the printing device associated |
| block 870 | with indicator 910g, a token associated with |
| | a print job being detected, but perhaps |
| | not yet received, by the printing device |
| | associated with indicator 910k, a token |
| | associated with a print job being started |
| | at the printing device associated with |
| | indicator 910m |

Touch screen region 906 can be used to provide and/or receive information, including but not limited to, simulating a touch screen of the printing device associated with playing back, controlling, and/or otherwise interacting with process recording software and/or data files of data captured during process recording. Touch screen region 906 can include copy element 920a, send element 920b, custom documents element 920c, job documents element 920d, removable memory element 920e, status/job cancel element 920f, device information element 920g, accessibility element 920h, system menu element 920k, language element 920m, and help element 920n. In other examples, touch screen region 906 can include more, fewer, and/or different elements than discussed herein.

Copy element 920a can be a button (or other element) used to instruct and/or represent an instruction to copy a document using the printing device. For example, copy element 920a can be selected to instruct the printing device associated with printer device playback user interface 902 to copy a document and/or copy element 920a can change (e.g., be displayed with a different color, font, etc.) to indicate a request for copying a document using the printing device was recorded in data files of data captured during process recording.

Send element 920b can be a button (or other element) used to instruct and/or represent an instruction to send an electronic document using the printing device. Send element 920b can be selected used to instruct and/or represent an instruction to send an electronic document in a similar fashion as discussed above in the context of copy element 920a.

Custom documents element 920c can be a button (or other element) used to instruct and/or represent an instruction to provide access to one or more custom document boxes storing documents associated with a particular user, user group, or other entity. If custom documents element 920c is selected and/or a stored selection of custom documents element 920c was recorded in data files of data captured during process recording, a dialog or other user interface element listing documents stored in the one or more custom document boxes can be provided; e.g., displayed in touch screen region 906.

Job documents element 920d can be a button (or other element) used to instruct and/or represent an instruction to provide access to one or more job document boxes storing documents associated with one or more print jobs (and perhaps other jobs) associated with the printing device. If job documents element 920d is selected and/or a stored selection of job documents element 920d was recorded in data files of data captured during process recording, a dialog or other user interface element listing documents stored in the one or more job document boxes can be provided; e.g., displayed in touch screen region 906.

Removable memory element 920e can be a button (or other element) used to instruct and/or represent an instruction to provide access to data stored in a removable memory attached to the printing device. If removable memory element 920e is selected and/or a stored selection of removable memory element 920e was recorded in data files of data captured during process recording and if the removable memory is currently attached to the printing device, a dialog or other user interface element listing data stored in the removable memory can be provided; e.g., displayed in touch screen region 906.

Status/job cancel element 920f can be a button (or other element) used to instruct and/or represent an instruction to provide status of and/or cancel a job, such as a print job, associated with the printing device. If status/job cancel element 920f is selected and/or a stored selection of status/job cancel element 920f was recorded in data files of data captured during process recording, a dialog or other user interface element providing status of jobs active on the printing device and/or an indication of a canceled print job can be provided; e.g., displayed in touch screen region 906.

Device information element 920g can be a button (or other element) used to instruct and/or represent an instruction to provide and/or modify information about the printing device (e.g., a printer name, network address information). If device information element 920g is selected and/or a stored selection of device information element 920g was recorded in data files of data captured during process recording, a dialog or other user interface element providing status of the printing device can be provided; e.g., displayed in touch screen region 906. In examples where the data files of data captured during process recording indicate device information for the printing device has been modified, the dialog or other user interface element for device information can indicate the modified device information.

Accessibility element 920h can be a button (or other element) used to instruct and/or represent an instruction to review and/or update accessibility information related to the printing device (e.g., font size settings, magnification level settings, text-to-speech settings). If accessibility element 920h is selected and/or a stored selection of accessibility element 920h was recorded in data files of data captured during process recording, a dialog or other element for accessibility information of the printing device can be provided; e.g., displayed in touch screen region 906. In examples where the data files of data captured during process recording indicate accessibility information has been modified, the dialog or other element for accessibility information can indicate the modified accessibility information.

System menu element 920k can be a button (or other element) used to instruct and/or represent an instruction to provide a menu or other element for reviewing and/or updating system information for the printing device. If system menu element 920k is selected and/or a stored selection of system menu element 920k was recorded in data files of data captured during process recording, a menu or other element for system information for the printing device can be provided; e.g., displayed in touch screen region 906. In examples where the data files of data captured during process recording indicate system information has been modified, the menu or other element for system information can indicate the modified system information.

Language element 920m can be a button (or other element) used to instruct and/or represent an instruction to provide and/or modify language information about the printing device (e.g., to have user interfaces of the printing device use Japanese, English, Chinese, French, Korean, German, and/or another language). If language element 920m is selected and/or a stored selection of language element 920m was recorded in data files of data captured during process recording, a dialog or other user interface element providing language information about the printing device can be provided; e.g., displayed in touch screen region 906. In examples where the data files of data captured during process recording indicate language information about the printing device has been modified, the dialog or other user interface element for language information about the printing device can indicate the modified language information.

Help element 920n can be a button (or other element) used to instruct and/or represent an instruction to provide help information about the printing device. If help element 920n is selected and/or a stored selection of help element 920n was recorded in data files of data captured during process recording, a dialog or other user interface element with the help information about the printing device can indicate can be provided.

Control panel region 908 can be used to provide and/or receive information, including but not limited to, simulating a control panel of the printing device associated with playing back, controlling, and/or otherwise interacting with process recording software and/or data files of data captured during process recording. Control panel region 908 can include system menu element 930a, counter element 930b, status/job cancel element 930c, help element 930d, accessibility display element 930e, home element 932a, copy element 932b, send element 932c, fax element 932d, process record element 932e, control panel display element 934a, keypad element 934b, start element 934c, clear element 936a, enter element 936b, stop element 936c, and power element 938a. In other examples, control panel region 908 can include more, fewer, and/or different elements than discussed herein.

System menu element 930a can be used to perform the functionality discussed above in the context of system menu element 920k while operating in control panel region 908.

Counter element 930b can be a button (or other element) used to instruct and/or represent an instruction to provide counter information for the printing device; e.g., a number of pages printed, a number of pages sent, a number of pages faxed, toner/ink levels, etc. If counter element 930b is selected and/or a stored selection of counter element 930b was recorded in data files of data captured during process recording, a dialog or other user interface element with the counter information for the printing device can indicate can be provided.

Status/job cancel element 930c can be used to perform the functionality discussed above in the context of status/job cancel element 920f while operating in control panel region 908.

Help element 930d can be used to perform the functionality discussed above in the context of help element 920n while operating in control panel region 908.

Accessibility display element 930e can be used to perform the functionality discussed above in the context of accessibility element 920h while operating in control panel region 908.

Home element 932a can be a button (or other element) used to instruct and/or represent an instruction to have control panel display element 934a display a default or “home” menu or other element.

Copy element 932b can be used to perform the functionality discussed above in the context of copy element 920a while operating in control panel region 908.

Send element 932c can be used to perform the functionality discussed above in the context of copy element 920b while operating in control panel region 908.

Fax element 932d can be a button (or other element) used to instruct and/or represent an instruction to fax a document using the printing device. For example, fax element 932d can be selected to instruct the printing device associated with printer device playback user interface 902 to fax a document and/or fax element 932d can change (e.g., be displayed with a different color, font, etc.) to indicate a request for faxing a document using the printing device was recorded in data files of data captured during process recording.

Process record element 932e can be a button (or other element) used to instruct and/or represent an instruction related to process recording on the printing device. For example, process record element 932e can be used to toggle activation and deactivation of process recording on the printing device and/or indicate whether process recording is activated or deactivated on the printing device. To indicate whether process recording is activated or deactivated on the printing device, process record element 932e can be displayed using a first style (e.g., be displayed with a first background color, first text color, first font, etc.) to indicate that process recording is activated on the printing device and can be displayed using a second style (e.g., be displayed with a second background color, second text color, second font, etc.) to indicate that process recording is deactivated on the printing device. As process record element 932e being displayed with the first style can visually differ from process record element 932e being displayed with the second style, process record element 932e can indicate whether process recording is activated or deactivated on the printing device.

Control panel display element 934a can be one or more displays (or other elements) used to provide and/or display information about the printing device (e.g., status information, alphanumeric data, paper jam clearing information) and/or display information recorded as being provided and/or displayed using control panel display element 934a during process recording.

Keypad element 934b can be one or more buttons (or other elements) used to allow entry of alphanumerical data and/or represent alphanumerical data entered and recorded during process recording.

Start element 934c can be a button (or other element) used to instruct and/or represent an instruction to start an operation of the printing device; e.g., start sending a document, start faxing a document, start copying a document. Start element 934c can change (e.g., be displayed with a different color, font, etc.) to indicate an operation of the printing device was started as recorded in data files of data captured during process recording.

Clear element 936a can be a button or other element that, when selected, removes or clears alphanumeric and/or other data provided to the printing device via control panel region 908. In some examples, when clear element 936a is selected, control panel display element 934a is cleared.

Enter element 936b can be a button or other element that, when selected, confirms that alphanumeric and/or other data provided to the printing device via control panel region 908 is to be used by the printing device.

Stop element 936c can be a button or other element that, when selected, that requests that the printing device stop a current operation; e.g., stop printing a document, stop sending a document, stop faxing a document.

Power element 938a can be a button or other element that, when selected, toggles between power being provided to the printing device and power not being provided to the printing device.

Playback control region 940 can be used to control playback of data recorded during process recording; e.g., in one or more data files. FIG. 9 shows that playback control region 940 can include fast reverse control 950 (indicated in FIG. 9 as “Fast Rev.”), reverse control 952, stop control 954, forward control 956, and fast forward control 958 (indicated in FIG. 9 as “Fast For.”). In other examples, playback control region 940 can include more, fewer, and/or different controls than discussed herein.

Fast reverse control 950 can, when selected, direct user interface 900 to have playback proceed in reverse time order at a relatively fast speed. Reverse control 952 can, when selected, direct user interface 900 to have playback proceed in reverse time order at a relatively slow speed. After fast reverse control 950 or reverse control 952 is selected, another selection of the respective control can stop playback from proceeding in reverse time order; i.e., fast reverse control 950 and reverse control 952 can act as toggles for proceeding with playback in reverse order.

Stop control 954 can, when selected, direct user interface 900 to have playback stop proceeding in either forward time order or backward time order.

Forward control 956 can, when selected, direct user interface 900 to have playback proceed in forward time order at a relatively slow speed. Fast forward control 958 can, when selected, direct user interface 900 to have playback proceed in forward time order at a relatively fast speed. After forward control 956 or fast forward control 958 is selected, another selection of the respective control can stop playback from proceeding in forward time order; i.e., forward control 956 and fast forward control 958 can act as toggles for proceeding with playback in forward order.

In some examples, playback user interface 900 can be used to playback, control, and/or otherwise interact with process recording software and/or data files of data captured during process recording associated with multiple printing devices. In these examples, playback user interface 900 can provide multiple instances of printer device playback user interface 902 and/or playback control region 940 as necessary to playback, control, and/or otherwise interact with process recording software and/or data files of data captured during process recording associated with the multiple printing devices.

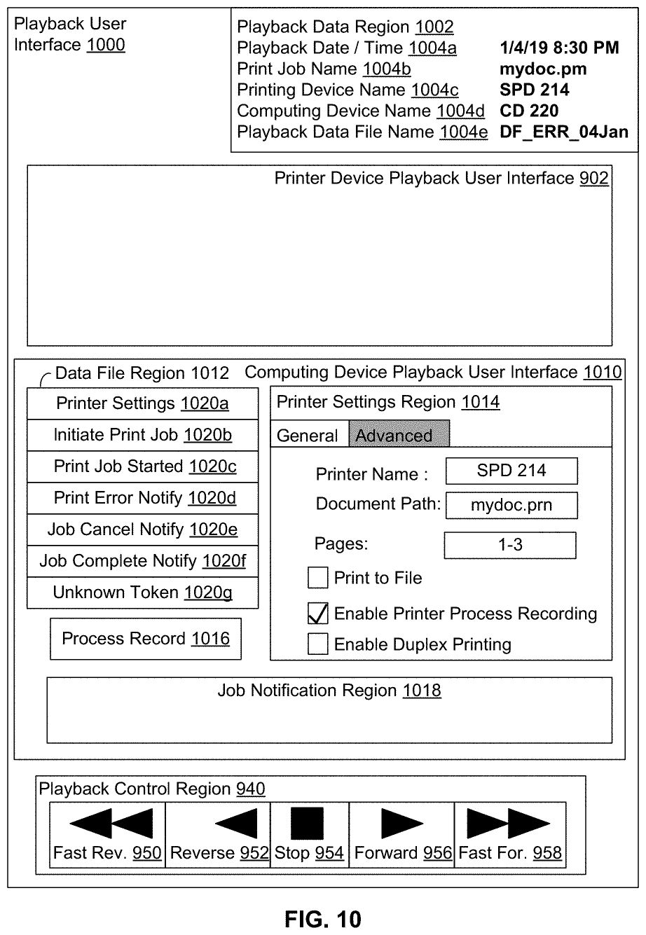

FIG. 10 illustrates a user interface 1000 for playing back data recorded during process recording, in accordance with example embodiments. Playback user interface 1000 can be used to playback, control, and/or otherwise interact with process recording software and/or data files of data captured during process recording.

More specifically, playback user interface 1000 can be used to playback, control, and/or otherwise interact with process recording software and/or data files of data captured during process recording associated with at least one printing device and at least one computing device. In some examples, playback user interface 1000 can be used to playback, control, and/or otherwise interact with process recording software and/or data files of data captured during process recording associated with at least one printing device and zero computing devices; in these examples, playback user interface 1000 can look and perform like playback user interface 900.

In some examples, playback user interface 1000 can be used to playback, control, and/or otherwise interact with process recording software and/or data files of data captured during process recording associated with multiple printing devices and/or multiple computing devices. In these examples, playback user interface 1000 can provide multiple instances of printer device playback user interface 902, playback control region 940, playback data region 1002, and/or computing device playback user interface 1010 as necessary to playback, control, and/or otherwise interact with process recording software and/or data files of data captured during process recording associated with the multiple printing devices and/or the multiple computing devices.

Playback user interface 1000 includes printer device playback user interface 902, playback control region 940, playback data region 1002, and computing device playback user interface 1010. Printer device playback user interface 902 and playback control region 940 of playback user interface 1000 can perform the same functionality for playback user interface 1000 as discussed above in the context of playback user interface 900 and FIG. 9.

Playback data region 1002 can provide data related to playback of one or more data files. FIG. 10 shows that playback data region 1002 can include playback date/time element 1004a, print job name element 1004b, printing device name element 1004c, computing device name element 1004d, and playback data file name element 1004e. In other examples, playback data region 1002 can include more, fewer, and/or different elements than discussed herein.

Playback date/time element 1004a can indicate timing information about an event currently being played back using playback user interface 1000. For example, playback date/time element 1004a shows that the event currently being played back using playback user interface 1000 is recorded as occurring on “1/4/19” at “8:30 PM”. If a playback is not being provided by playback user interface 1000, playback date/time element 1004a can be blank.

Print job name element 1004b can indicate timing information about an event currently being played back using playback user interface 1000. For example, print job name element 1004b shows that the event currently being played back using playback user interface 1000 is recorded as being associated with a print job named “mydoc.pm” If a playback is not being provided by playback user interface 1000, print job name element 1004b can be blank.

Printing device name element 1004c can indicate a name (or names) one or more printing devices associated with a playback provided by playback user interface 1000. For example, printing device name element 1004c shows that the playback provided using playback user interface 1000 is associated with a printing device named “SPD 214”. If a playback is not being provided by playback user interface 1000, printing device name element 1004c can be blank.

Computing device name element 1004d can indicate a name (or names) one or more computing devices associated with a playback provided by playback user interface 1000. For example, computing device name element 1004d shows that the playback provided using playback user interface 1000 is associated with a computing device named “CD 220”. If a playback is not being provided by playback user interface 1000, computing device name element 1004d can be blank.

Playback data file name element 1004e can indicate the names of one or more data files storing data currently being played back using playback user interface 1000. For example, FIG. 10 shows that a data file named “DF_ERR_04Jan” is currently being played back using playback user interface 1000. If a playback is not being provided by playback user interface 1000, playback data file name element 1004e can be blank.

Computing device playback user interface 1010 can be used to playback and/or otherwise interact with a computing device, process recording software, and/or data files of data captured during process recording associated with the computing device. FIG. 10 shows that computing device playback user interface 1010 can include data file region 1012, printer settings region 1014, process record element 1016, and job notification region 1018. In other examples, computing device playback user interface 1010 can include more, fewer, and/or different elements than discussed herein.

Data file region 1012 can include one or more indicators or other elements related to data and/or tokens associated with process recording software and/or data files of data captured during process recording, where the data and/or tokens (and consequently the indicators) are associated with the computing device. The indicators can include printer settings indicator 1020a, initiate print job indicator 1020b, print job started indicator 1020c, print error notify indicator 1020d, job cancel notify indicator 1020e, job complete notify indicator 1020f, and unknown token indicator 1020g. In other examples, data file region 1012 can include more, fewer, and/or different indicators than discussed herein.

Printer settings indicator 1020a can indicate that a token associated with settings data of a printing device modified by a computing device has been processed by computing device playback user interface 1010. Examples of settings data of a printing device modified by the computing device include, but are not limited to, settings related to a print job (or other procedure) associated with the printing device modified by the computing device, data about a name of the printing device, data about network addresses of the printing device modified by the computing device, and data controlling process recording on the printing device that was modified by the computing device, and feature and option settings for the printing device that were modified by the computing device.

Initiate print job indicator 1020b can indicate that a token associated with a print job being initiated by the computing device has been processed by computing device playback user interface 1010.

Print job started indicator 1020c can indicate that a token associated with a print job being started has been processed by computing device playback user interface 1010. For example, after a print job is initiated by a computing device, a printing device or another device (e.g., a print server) can provide a notification that the print job has actually started at a printing device. If reception of the notification that the print job has actually started at a printing device is recorded during process recording on the computing device, then the recorded data about the notification that the print job has actually started at a printing device can lead to generation of a token associated with a print job being started.

Print error notify indicator 1020d can indicate that a token associated with an erroneous print job has been processed by computing device playback user interface 1010.

Job cancel notify indicator 1020e can indicate that a token associated with a canceled print job has been processed by computing device playback user interface 1010.

Job complete notify indicator 1020f can indicate that a token associated with a completed print job has been processed by computing device playback user interface 1010.

Unknown token indicator 1020g can indicate that an unknown token, which is other than a token associated with one or more of indicators 1020a, 1020b, 1020c, 1020d, 1020e, and 1020f has been processed by computing device playback user interface 1010.

Table 2 below shows an example mapping of the tokens mentioned in the context of method 800 to the tokens mentioned above in the context of computing device playback user interface 1010.

TABLE 2

| | Corresponding token(s) of data file |
|---|---|
| Token of method 800 | region 904 |
| End-of-file token associated | Not illustrated in data file region 1012. |
| with block 820 | |
| Start-printer-process token | Not illustrated in data file region 1012. |
| associated with block 830 | |
| Other-process token | An unknown token associated with |
| associated with block 840 | indicator 1020g |
| Printer-sub-device-event token | Not illustrated in data file region 1012. |
| associated with block 850 | |
| User-setting token | A token associated with settings data of |
| associated with block 860 | a printing device modified by a computing |
| | device associated with indicator 1020a, |
| Print-job token associated | A token associated with a print job |
| with block 870 | being initiated by the computing device |
| | associated with indicator 1020b, a token |
| | associated with a print job being started |
| | associated with indicator 1020c, a token |
| | associated with an erroneous print job |
| | associated with indicator 1020d, a token |
| | associated with a canceled print job |
| | associated with indicator 1020e, and a |
| | token associated with a completed print |
| | job associated with indicator 1020f. |

Printer settings region 1014 can be a dialog or other element for reviewing and/or updating settings of the computing device related to printing devices. FIG. 10 shows that printer settings region 1014 includes “General” settings of the computing device related to a print job using printing device “SPD 214” where pages “1-3” are to be printed from a document whose path is “mydoc.prn”. Printer settings region 1014 also indicates that the document mydoc.prn is not to be printed to a file, that process recording is to be enabled by the computing device for a print job to print the document mydoc.prn, and that duplex printing is not enabled for this print job. In other examples, more, fewer, and/or different settings of the computing device related to printing devices can be reviewed and/or updated using printer settings region 1014.

Process record element 1016 can be a button (or other element) used to instruct and/or represent an instruction related to process recording on the computing device. For example, process record element 1016 can be used to toggle activation and deactivation of process recording on the computing device and/or process record element 1016 can change (e.g., be displayed with a different color, font, etc.) to indicate that process recording is activated on the on the computing device in comparison to process recording being deactivated on the computing device.

Process record element 1016 can be a button (or other element) used to instruct and/or represent an instruction related to process recording on the computing device. For example, process record element 1016 can be used to toggle activation and deactivation of process recording on the computing device and/or indicate whether process recording is activated or deactivated on the computing device. To indicate whether process recording is activated or deactivated on the computing device, process record element 1016 can be displayed using a first style (e.g., be displayed with a first background color, first text color, first font, etc.) to indicate that process recording is activated on the computing device and can be displayed using a second style (e.g., be displayed with a second background color, second text color, second font, etc.) to indicate that process recording is deactivated on the computing device. As process record element 1016 being displayed with the first style can visually differ from process record element 1016 being displayed with the second style, process record element 1016 can indicate whether process recording is activated or deactivated on the computing device.

Job notification region 1018 can be a display or other element for providing information related to print jobs and perhaps other jobs provided to the computing device. In some examples, the information related to print jobs and perhaps other jobs can be recorded in a data file and job notification region 1018 can be used to provide the recorded information.

### IV. Example Methods of Operation

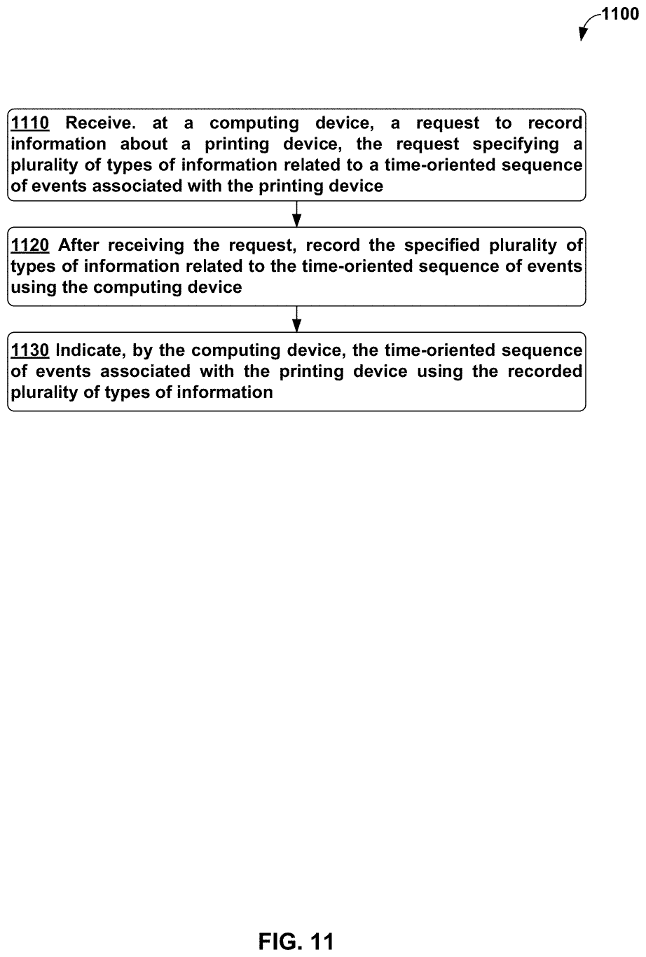

FIG. 11 is a flowchart for a method, in accordance with example embodiments. Method 1100 can be carried out by a computing device, such as computing device 100.

Method 1100 can begin at block 1110, where the computing device can receive a request to record information about a printing device, the request specifying a plurality of types of information related to a time-oriented sequence of events associated with the printing device; such as discussed at least in the context of FIGS. 3, 4, 5, 6, 9, and 10.

At block 1120, the computing device can, after receiving the request, be used to record the specified plurality of types of information related to the time-oriented sequence of events, such as discussed at least in the context of FIGS. 5 and 6.

At block 1130, the computing device can indicate the time-oriented sequence of events associated with the printing device using the recorded plurality of types of information, such as discussed at least in the context of FIGS. 6-10.

In some embodiments, the plurality of types of information can include two or more of: a type of information for keystrokes related to the printing device, a type of information for user interface device events other than keystrokes related to the printing device, a type of information for configuration settings of the printing device, a type of information for sub-devices of the printing device, a type of information for print jobs of the printing device, a type of information for paper jams of the printing device, an audio type of information, and/or a video type of information, such as discussed at least in the context of FIG. 4

In some embodiments, the type of information for configuration settings of the printing device can relate to one or more of: a printer engine specification, a firmware version of the printing device, a feature and/or option setting of the printing device, a finishing option of the printing device, and/or a system setting of the printing device, such as discussed at least in the context of FIG. 9.

In some embodiments, the type of information for sub-devices of the printing device can relate to one or more of: a door of the printing device, a tray of the printing device, a lever of the printing device, a cover of the printing device, and/or a control panel of the printing device, such as discussed at least in the context of FIGS. 6, 7, and 9.

In some embodiments, receiving the request to record information about the printing device can include receiving the request to record information using a user interface of a printer driver executing on the computing device, such as discussed at least in the context of FIG. 3.

In some embodiments, receiving the request to record information about the printing device can include receiving the request to record information using a user interface of an application executing on the computing device, such as discussed at least in the context of FIGS. 3 and 4.

In some embodiments, the computing device can include the printing device; then, receiving the request to record information about the printing device can include receiving the request to record information using a user interface of the printing device, such as discussed at least in the context of FIGS. 3 and 4.

In some embodiments, the computing device can include the printing device; then, receiving the request to record information about the printing device can include receiving the request to record information using a job command of the printing device, such as discussed at least in the context of FIGS. 3 and 4.

In some embodiments, the computing device can include the printing device; then, receiving the request to record information about the printing device can include: determining that an external device has connected to the printing device; and receiving the request to record information at the printing device from the external device, such as discussed at least in the context of FIG. 3.

In some embodiments, the computing device differs from the printing device; then, recording the specified plurality of types of information related to the time-oriented sequence of events can include recording the specified plurality of types of information related to the time-oriented sequence of events at both the computing device and the printing device, such as discussed at least in the context of FIGS. 6 and 10.

In some embodiments, indicating the time-oriented sequence of events associated with the printing device using the recorded plurality of types of information can include: parsing the recorded plurality of types of information into one or more tokens associated with the time-oriented sequence of events associated with the printing device; generating a simulation of the time-oriented sequence of events associated with the printing device based on the one or more tokens; and displaying the simulation of the time-oriented sequence of events associated with the printing device using a graphical user interface of the computing device, such as discussed at least in the context of FIGS. 8-10.

In some embodiments, the one or more tokens can include one or more of: a token associated with an event related to a print job, a token associated with an event related to a user interface of the printing device, a token associated with an event related to a sub-device of the printing device, and/or a token associated with an event related to a process of the printing device, such as discussed at least in the context of FIGS. 8-10.

In some embodiments, indicating the time-oriented sequence of events associated with the printing device using the recorded plurality of types of information can include: generating a data file of one or more data items that include the recorded plurality of types of information, where a data item of the one or more data items can include event data about a type of information being recorded, and timestamp data indicating when information for the data item is being recorded, such as discussed at least in the context of FIGS. 6 and 7.

In some embodiments, the data item can further include a location where additional information related to the data item is stored and/or a copy of input data associated with the event data, such as discussed at least in the context of FIG. 7.

In some embodiments, indicating the time-oriented sequence of events associated with the printing device using the recorded plurality of types of information can include: performing one or more events of the time-oriented sequence of events as recorded in the recorded plurality of types of information on the printing device by at least: executing a process of the printing device related to an event of the time-oriented sequence of events; modifying a user interface of the printing device; and/or modifying a configuration of the printing device, such as discussed at least in the context of FIGS. 8-10.

In some embodiments, executing the process of the printing device can include executing one or more of: a color registration process, a color calibration process, a factory reset process, a memory initialization process, a disk-related process, and/or a profiling process, such as discussed at least in the context of FIG. 8

In some embodiments, modifying the user interface of the printing device can include one or more of: activating a key or button of the user interface of the printing device, enabling a key or button of the user interface of the printing device, and/or disabling a key or button of the user interface of the printing device, such as discussed at least in the context of FIG. 8.

In some embodiments, modifying the configuration of the printing device can include one or more of: setting a configuration setting of the printing device, and/or resetting a configuration setting of the printing device, such as discussed at least in the context of FIG. 9.

The illustrative embodiments described in the detailed description, figures, and claims are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

With respect to any or all of the ladder diagrams, scenarios, and flow charts in the figures and as discussed herein, each block and/or communication may represent a processing of information and/or a transmission of information in accordance with example embodiments. Alternative embodiments are included within the scope of these example embodiments. In these alternative embodiments, for example, functions described as blocks, transmissions, communications, requests, responses, and/or messages may be executed out of order from that shown or discussed, including substantially concurrent or in reverse order, depending on the functionality involved. Further, more or fewer blocks and/or functions may be used with any of the ladder diagrams, scenarios, and flow charts discussed herein, and these ladder diagrams, scenarios, and flow charts may be combined with one another, in part or in whole.

A block that represents a processing of information may correspond to circuitry that can be configured to perform the specific logical functions of a method or technique. Alternatively or additionally, a block that represents a processing of information may correspond to a module, a segment, or a portion of program code (including related data). The program code may include one or more instructions executable by a processor for implementing specific logical functions or actions in the method or technique. The program code and/or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code and/or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

1. A method, comprising:
receiving, at a computing device, a request to record information about a printing device, the request specifying a plurality of types of information related to a time-oriented sequence of events associated with the printing device, wherein the plurality of types of information comprise two or more of: a type of information for keystrokes related to the printing device, a type of information for user interface device events other than keystrokes related to the printing device, a type of information for configuration settings of the printing device, a type of information for sub-devices of the printing device, a type of information for print jobs of the printing device, a type of information for paper jams of the printing device, an audio type of information, and/or a video type of information;
after receiving the request, recording the specified plurality of types of information related to the time-oriented sequence of events using the computing device; and
indicating, by the computing device, the time-oriented sequence of events associated with the printing device using the recorded plurality of types of information

2. (canceled)

3. The method of claim 2, wherein the type of information for configuration settings of the printing device relates to one or more of: a printer engine specification, a firmware version of the printing device, a feature and/or option setting of the printing device, a finishing option of the printing device, and/or a system setting of the printing device.

4. The method of claim 2, wherein the type of information for sub-devices of the printing device relates to one or more of: a door of the printing device, a tray of the printing device, a lever of the printing device, a cover of the printing device, and/or a control panel of the printing device.

5. The method of claim 1, wherein receiving the request to record information about the printing device comprises receiving the request to record information using a user interface of a printer driver executing on the computing device.

6. The method of claim 1, wherein receiving the request to record information about the printing device comprises receiving the request to record information using a user interface of an application executing on the computing device.

7. The method of claim 1, wherein the computing device comprises the printing device, and wherein receiving the request to record information about the printing device comprises receiving the request to record information using a user interface of the printing device.

8. The method of claim 1, wherein the computing device comprises the printing device, and wherein receiving the request to record information about the printing device comprises receiving the request to record information using a job command of the printing device.

9. The method of claim 1, wherein the computing device comprises the printing device, and wherein receiving the request to record information about the printing device comprises:
determining that an external device has connected to the printing device; and
receiving the request to record information at the printing device from the external device.

10. The method of claim 1, wherein the computing device differs from the printing device, and wherein recording the specified plurality of types of information related to the time-oriented sequence of events comprises recording the specified plurality of types of information related to the time-oriented sequence of events at both the computing device and the printing device.

11. The method of claim 1, wherein indicating the time-oriented sequence of events associated with the printing device using the recorded plurality of types of information comprises:
parsing the recorded plurality of types of information into one or more tokens associated with the time-oriented sequence of events associated with the printing device;
generating a simulation of the time-oriented sequence of events associated with the printing device based on the one or more tokens; and
displaying the simulation of the time-oriented sequence of events associated with the printing device using a graphical user interface of the computing device.

12. The method of claim 11, wherein the one or more tokens comprise one or more of: a token associated with an event related to a print job, a token associated with an event related to a user interface of the printing device, a token associated with an event related to a sub-device of the printing device, and/or a token associated with an event related to a process of the printing device.

13. The method of claim 1, wherein indicating the time-oriented sequence of events associated with the printing device using the recorded plurality of types of information comprises:
generating a data file of one or more data items that include the recorded plurality of types of information, wherein a data item of the one or more data items comprises event data about a type of information being recorded, and timestamp data indicating when information for the data item is being recorded.

14. The method of claim 13, wherein the data item further comprises a location where additional information related to the data item is stored and/or a copy of input data associated with the event data.

15. The method of claim 1, wherein indicating the time-oriented sequence of events associated with the printing device using the recorded plurality of types of information comprises:
performing one or more events of the time-oriented sequence of events as recorded in the recorded plurality of types of information on the printing device by at least:
executing a process of the printing device related to an event of the time-oriented sequence of events;
modifying a user interface of the printing device; and/or
modifying a configuration of the printing device.

16. The method of claim 15, wherein executing the process of the printing device comprises executing one or more of: a color registration process, a color calibration process, a factory reset process, a memory initialization process, a disk-related process, and/or a profiling process.

17. The method of claim 15, wherein modifying the user interface of the printing device comprises one or more of:
activating a key or button of the user interface of the printing device,
enabling a key or button of the user interface of the printing device, and/or
disabling a key or button of the user interface of the printing device.

18. The method of claim 15, wherein modifying the configuration of the printing device comprises one or more of:
setting a configuration setting of the printing device, and/or
resetting a configuration setting of the printing device.

19. A computing device, comprising:
one or more processors; and
data storage configured to store at least computer-readable instructions that comprise instructions that, when executed by the one or more processors, cause the computing device to perform tasks comprising:
receiving a request to record information about a printing device, the request specifying a plurality of types of information related to a time-oriented sequence of events associated with the printing device, wherein the plurality of types of information comprise two or more of: a type of information for keystrokes related to the printing device, a type of information for user interface device events other than keystrokes related to the printing device, a type of information for configuration settings of the printing device, a type of information for sub-devices of the printing device, a type of information for print jobs of the printing device, a type of information for paper jams of the printing device, an audio type of information, and/or a video type of information;
after receiving the request, recording the specified plurality of types of information related to the time-oriented sequence of events; and
indicating the time-oriented sequence of events associated with the printing device using the recorded plurality of types of information.

20. (canceled)

21. A method, comprising:
receiving, at a computing device, a request to record information about a printing device, the request specifying a plurality of types of information related to a time-oriented sequence of events associated with the printing device;
after receiving the request, recording the specified plurality of types of information related to the time-oriented sequence of events using the computing device; and
indicating, by the computing device, the time-oriented sequence of events associated with the printing device using the recorded plurality of types of information, wherein indicating the time-oriented sequence of events associated with the printing device using the recorded plurality of types of information comprises:
performing one or more events of the time-oriented sequence of events as recorded in the recorded plurality of types of information on the printing device by at least:
executing a process of the printing device related to an event of the time-oriented sequence of events;
modifying a user interface of the printing device; and/or
modifying a configuration of the printing device.
